(19) United States
(12) Patent Application Publication
(10) Pub. No.: US 2023/0223025 A1
(43) Pub. Date: Jul. 13, 2023

(54) INFORMATION PROCESSING APPARATUS, INFORMATION PROCESSING METHOD, AND COMPUTER PROGRAM

(71) Applicant: SONY GROUP CORPORATION, TOKYO (JP)

(72) Inventors: SHINICHI KAWANO, TOKYO (JP); KENJI SUGIHARA, TOKYO (JP); HIRO IWASE, TOKYO (JP)

(21) Appl. No.: 18/000,903

(22) PCT Filed: Jun. 7, 2021
(86) PCT No.: PCT/JP2021/021602

§ 371 Date: Dec. 6, 2022

(30) Foreign Application Priority Data
Jun. 15, 2020 (JP) 2020-103327

(51) Int. Cl. G10L 15/26; G10L 17/02; G02B 27/01

(52) U.S. Cl. CPC G10L 15/26; G10L 17/02; G02B 27/017; G02B 2027/014

(57) ABSTRACT

Smooth text communication is realized between users. An information processing apparatus according to the present disclosure includes a control unit configured to: determine speech generated by a first user on the basis of sensing information of at least one sensor apparatus sensing at least one of the first user and a second user communicating with the first user on the basis of the speech generation of the first user; and control information output to the first user on the basis of a result of the determination of the speech generation of the first user.

### TECHNICAL FIELD

The present disclosure relates to an information processing apparatus, an information processing method, and a computer program.

### BACKGROUND ART

In accordance with the spread of voice recognition, it is expected that the number of opportunities for text communication such as a social networking service (SNS) chatting, e-mails, and the like will increase.

As one example, a case in which text-based communication is assumed to be performed in a state in which a speaker (for example, a normal listener) faces a listener (for example, a hearing-impaired person) may be conceived. Voice recognition of details spoken by a speaker is performed using a terminal of the speaker, and text that is a result of the voice recognition is transmitted to a terminal of the listener. In this case, there is a problem in that the speaker does not know the pace at which the details spoken by him or her are being read by the listener and whether the details spoken by him or her have been understood by the listener. Even when the speaker thinks that he or she carefully generates speech slowly and clearly, there are a case in which the pace of the generated speech is faster than the pace of understanding of the listener and a case in which voice recognition of the generated speech is not correctly performed. In such a case, the listener cannot correctly understand a speaker's intention and cannot smoothly perform communication. It is also difficult for the listener to interrupt during speech generation of the speaker and convey to the speaker a situation of lack of understanding. As a result, a conversation becomes one-sided and does not continue joyfully.

As below, in PTL 1, a method of controlling display in a terminal of a listener in accordance with a display amount of text or an input amount of voice information has been proposed. However, a situation in which a listener cannot correctly understand a speaker's intention or details of generated speech such as a case in which error in voice recognition occurs, words that a listener does not know are input, a situation in which voice recognition is performed on speech unintentionally generated by a speaker, or the like may occur.

### CITATION LIST

### Patent Literature

[PTL 1]

WO 2017/191713

### SUMMARY

### Technical Problem

The present disclosure provides an information processing apparatus and an information processing method realizing smooth communication.

### Solution to Problem

An information processing apparatus according to the present disclosure includes a control unit configured to: determine speech generated by a first user on the basis of sensing information of at least one sensor apparatus sensing with respect to at least one of the first user and a second user communicating with the first user on the basis of speech generation of the first user; and control information output to the first user on the basis of a result of the determination of the speech generated by the first user.

An information processing method according to the present disclosure includes: determining speech generated by a first user on the basis of sensing information of at least one sensor apparatus sensing at least one of the first user and a second user communicating with the first user on the basis of the speech generation of the first user; and controlling information output to the first user on the basis of a result of the determination of the speech generation of the first user.

A computer program according to the present disclosure causing a computer to execute: a step of determining speech generated by a first user on the basis of sensing information of at least one sensor apparatus sensing at least one of the first user and a second user communicating with the first user on the basis of the speech generation of the first user; and a step of controlling information output to the first user on the basis of a result of the determination of the speech generation of the first user.

### BRIEF DESCRIPTION OF DRAWINGS

FIG. 1 is a block diagram illustrating a configuration example of an information processing system according to a first embodiment.

FIG. 2 is a block diagram of a terminal including an information processing apparatus of a speaker side.

FIG. 3 is a block diagram of a terminal including an information processing apparatus of a listener side.

FIG. 4 is a diagram illustrating carefulness determination using voice recognition.

FIG. 5 is a flowchart illustrating an operation example of a terminal of a speaker.

FIG. 6 is a flowchart illustrating an operation example of a terminal of a listener.

FIG. 7 is a diagram illustrating a specific example in which a degree of coincidence is calculated.

FIG. 8 is a flowchart illustrating an operation example of a terminal of a speaker.

FIG. 9 is a flowchart illustrating an operation example of a terminal of a listener.

FIG. 10 is a diagram illustrating a specific example in which a degree of a confronting state is calculated.

FIG. 11 is a flowchart illustrating an operation example of a terminal of a speaker.

FIG. 12 is a flowchart illustrating an operation example of a terminal of a listener.

FIG. 13 is a flowchart illustrating an operation example of a terminal of a speaker.

FIG. 14 is a flowchart illustrating an operation example of a terminal of a listener.

FIG. 15 is a flowchart illustrating an operation example of a terminal of a speaker.

FIG. 16 is a flowchart illustrating an operation example of a terminal of a listener.

FIG. 17 is a diagram illustrating a display example of a case in which careful speech generation is determined.

FIG. 18 is a diagram illustrating a display example of a case in which non-careful speech generation is determined.

FIG. 19 is a diagram illustrating a display example of a case in which non-careful speech generation is determined.

FIG. 20 is a flowchart illustrating the entire operation according to this embodiment.

FIG. 21 is block diagram of a terminal including an information processing apparatus of a speaker side according to a second embodiment.

FIG. 22 is a block diagram of a terminal including an information processing apparatus of a listener side.

FIG. 23 is a flowchart illustrating an operation example of a terminal of a speaker.

FIG. 24 is a flowchart illustrating an operation example of a terminal of a listener.

FIG. 25 is a diagram illustrating a specific example in which an understanding status is determined on the basis of a staying time of a visual line.

FIG. 26 is a diagram illustrating an example in which a position of a visual line in a depth direction is calculated using congestion information.

FIG. 27 is a flowchart illustrating an operation example of a terminal of a speaker.

FIG. 28 is a flowchart illustrating an operation example of a terminal of a listener.

FIG. 29 is a flowchart illustrating an operation example of a terminal of a speaker.

FIG. 30 is a diagram illustrating an example in which an output form of text is changed in accordance with a listener's understanding status.

FIG. 31 is a diagram illustrating an example of text acquired by performing voice recognition on speech generated by a speaker.

FIG. 32 is a diagram illustrating another example of text acquired by performing voice recognition of speech generated by a speaker.

FIG. 33 is a diagram illustrating an example in which a display form of text is changed in accordance with an understanding status of a listener.

FIG. 34 is a diagram illustrating an example in which a display form of text is changed in accordance with an understanding status of a listener.

FIG. 35 is a block diagram of a terminal of a listener according to Modified example 1 of a second embodiment.

FIG. 36 is a diagram illustrating a specific example in which an incomprehensibility notification of text is transmitted to a speaker side.

FIG. 37 is a diagram illustrating a specific example of Modified example 2 of the second embodiment.

FIG. 38 is a diagram illustrating a specific example of Modified example 3 of the second embodiment.

FIG. 39 is a block diagram of a terminal of a speaker according to a third embodiment.

FIG. 40 is a diagram illustrating an example of sign denotations decorated in accordance with paralanguage information.

FIG. 41 is a diagram illustrating an example of decorations of text.

FIG. 42 is a diagram illustrating an example of the hardware configuration of an information processing apparatus according to a fourth embodiment.

FIG. 43 is a block diagram illustrating a configuration example of an information processing system according to a fifth embodiment.

FIG. 44 is a diagram illustrating an example of the hardware configuration of an information processing apparatus according to the present disclosure.

### DESCRIPTION OF EMBODIMENTS

Hereinafter, embodiments of the present disclosure will be described with reference to the drawings. In one or more embodiments shown in the present disclosure, the elements included in each embodiment can be combined with each other, and the combined result is also part of the embodiments shown in the present disclosure.

### First Embodiment

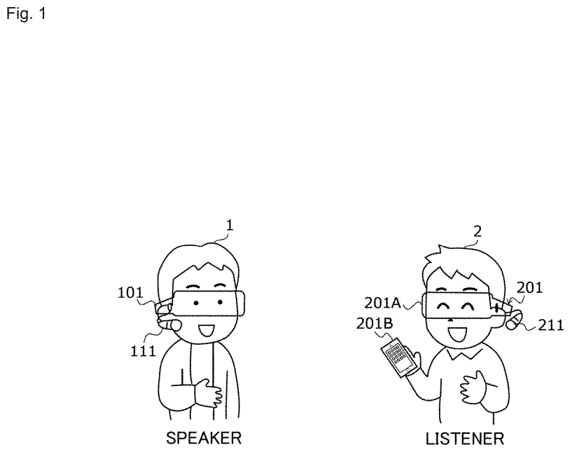

FIG. 1 is a block diagram illustrating a configuration example of an information processing system according to a first embodiment of the present disclosure. The information processing system illustrated in FIG. 1 includes a terminal 101 for a speaker who is user 1 and a terminal 201 for a listener who is user 2 performing text-based communication with the speaker. In this embodiment, although a case in which a speaker is a normal listener, and a listener is a hearing-impaired person is assumed, the speaker and the listener are not particularly limited to specific persons as long as they are persons communicating with each other. The user 2 communicates with the user 1 on the basis of generated speech of a speaker. The terminal 101 and the terminal 201 can communicate with each other using an arbitrary communication scheme in a wireless or wired manner.

Each of the terminal 101 and the terminal 201 includes an information processing apparatus that includes an input unit, an output unit, a control unit, and a storage unit. Specific examples of each of the terminal 101 and the terminal 201 include a wearable device, a mobile terminal, a personal computer (PC), a wearable device, and the like. Examples of the wearable device include augmented reality (AR) glasses, smart glasses, mixed reality (MR) glasses, and a virtual reality (VR) head mount display. Examples of the mobile terminal include a smartphone, a tablet terminal, and a portable phone. Examples of the personal computer include a desktop PC and a notebook PC. The terminal 101 or the terminal 201 may include a plurality of the examples described above. In the example illustrated in FIG. 1, the terminal 101 includes smart glasses, and the terminal 201 includes smart glasses 201A and a smartphone 201B. Each of the terminal 101 and the terminal 201 includes sensor units such as microphones 111 and 211, a camera, and the like as input units and includes a display unit as an output unit. The configurations of the terminal 101 and the terminal 201 are examples, and thus the terminal 101 may include a smartphone, and the terminal 101 and the terminal 201 may include sensor units other than the microphones, the camera, and the like.

A speaker and a listener, for example, in a state in which they are facing each other, perform text-based communication using voice recognition. For example, voice recognition of details (a message) spoken by a speaker is performed using the terminal 101, and text that is a result of the voice recognition is transmitted to the terminal 201 of the listener. The text is displayed on a screen of the terminal 201. The listener reads the text displayed on the screen and understands the details spoken by the speaker. In this embodiment, by determining speech generated by a speaker and controlling information to be output (presented) to the speaker in accordance with a result of the determination, information according to the result of the determination is fed back. As an example in which speech generated by a speaker is determined, it is determined whether speech that can be easily understood by a listener, that is, careful speech has been made (carefulness determination).

More specifically, an example of careful speech includes speech which a listener can easily hear (that with a loud voice, clear articulation, and an appropriate speed), that whilst speaking facing a listener, that whilst speaking with a listener at an appropriate distance, or the like. By speaking face-to-face, a listener can see the mouth and an expression of a speaker, and thus generated speech can be easily understood, and thus it is considered to be careful. In addition, an appropriate speed is a speed that is not too low and is not too high. An appropriate distance is a distance that is not too long and is not too short.

A speaker checks information according to a determination result indicating weather careful speech has been made (for example, checks the information on a screen of the terminal 101). In accordance with this, in a case in which carefulness is insufficient, the speaker can correct a behavior (vocalization, a posture, a distance to a partner, and the like) such that speech that can be easily heard by a listener is spoken. In accordance with this, speech generation of the speaker becoming one-sided, and the speech generation progressing in a state in which a listener cannot understand the generated speech (in an overflowed state for the listener) can be prevented, and thus smooth communication can be realized. Hereinafter, this embodiment will be described in further detail.

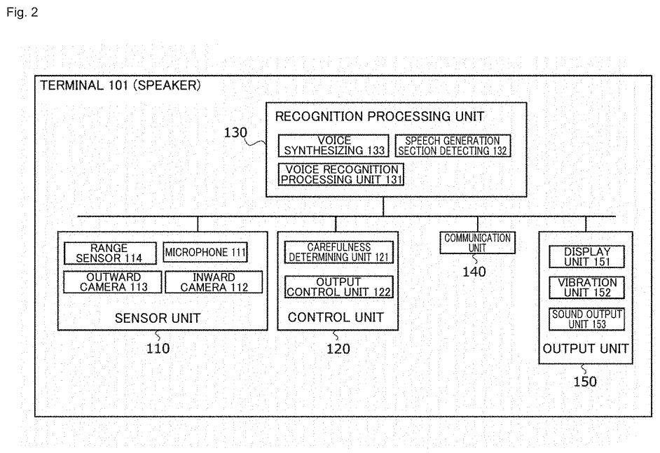

FIG. 2 is a block diagram of the terminal 101 including an information processing apparatus of a speaker side according to this embodiment. The terminal 101 illustrated in FIG. 2 includes a sensor unit 110, a control unit 120, a recognition processing unit 130, a communication unit 140, and an output unit 150. In addition, a storage unit that stores data or information generated by each unit and data or information required for a process performed in each unit may be included.

The sensor unit 110 includes a microphone 111, an inward camera 112, an outward camera 113, and a range sensor 114. Various sensor apparatuses described here are examples, and any other sensor apparatus may be included in the sensor unit 110.

The microphone 111 collects speech generated by a speaker and converts sound into an electric signal. The inward camera 112 images at least a part (a face, a hand, an arm, a leg, a foot, an entire body, or the like) of a body of a speaker. The outward camera 113 images at least a part (a face, a hand, an arm, a leg, a foot, an entire body, or the like) of a body of a listener. The range sensor 114 is a sensor that measures a distance to a target object. Examples of the range sensor 114 include a time of flight (TOF) sensor, a light detection and ranging (LiDAR), a stereo camera, and the like. Information from sensing by the sensor unit 110 corresponds to sensing information.

The control unit 120 controls the entire terminal 101. The control unit 120 controls the sensor unit 110, the recognition processing unit 130, the communication unit 140, and the output unit 150. The control unit 120 determines speech generated by a speaker on the basis of sensing information acquired by sensing at least one of a speaker and a listener using the sensor unit 110, sensing information acquired by sensing at least one of the speaker and the listener using a sensor unit 210 of the terminal 201, or both thereof. The control unit 120 controls information to be output (presented) to the speaker on the basis of a result of the determination. In more detail, the control unit 120 includes a carefulness determining unit 121 and an output control unit 122. The carefulness determining unit 121 determines whether speech generated by a speaker is careful speech for a listener (speech that can be easily understood, speech that can be easily heard, or the like). The output control unit 122 causes the output unit 150 to output information according to a result of the determination acquired by the carefulness determining unit 121.

The recognition processing unit 130 includes a voice recognition processing unit 131, a speech generation section detecting unit 132, and a voice synthesizing unit 133. The voice recognition processing unit 131 performs voice recognition on the basis of a voice signal collected by the microphone 111 and acquires text. For example, the voice recognition processing unit converts details (a message) spoken by a speaker into a message of text. The speech generation section detecting unit 132 detects a time over which a speaker generates speech (a speech generation section) on the basis of a voice signal collected by the microphone 111. The voice synthesizing unit 133 converts given text into a voice signal.

The communication unit 140 communicates with the terminal 201 of a listener in a wired manner or a wireless manner using an arbitrary communication scheme. The communication may be communication via a wide area network such as a local network, a cellular mobile communication network, the Internet, or the like or may be a short-range data communication such as B1uetooth.

The output unit 150 is an output apparatus that outputs (presents) information to a speaker. The output unit 150 includes a display unit 151, a vibration unit 152, and a sound output unit 153. The display unit 151 is a display apparatus that displays data or information on a screen. Examples of the display unit 151 include a liquid crystal display apparatus, an organic light emitting electro luminescence (EL) display apparatus, a plasma display apparatus, a light emitting diode (LED) display apparatus, a flexible organic EL display, and the like. The vibration unit 152 is a vibration apparatus (vibrator) that generates vibrations. The sound output unit 153 is a voice output apparatus (speaker) that converts an electric signal into sound. Examples of elements included in the output illustrated here are merely examples, and some of the elements may not be provided, or any other element may be included in the output unit 150.

The recognition processing unit 130 may be configured as a server on a communication network such as cloud or the like. In such a case, the terminal 101 accesses a server including the recognition processing unit 130 using the communication unit 140. The carefulness determining unit 121 of the control unit 120 may be disposed not in the terminal 101 but in the terminal 201 to be described below.

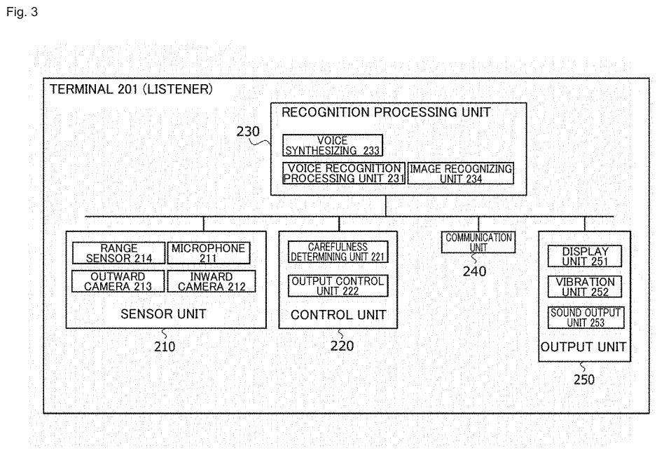

FIG. 3 is a block diagram of a terminal 201 including an information processing apparatus of a listener side. The configuration of the terminal 201 is basically similar to the terminal 101 except that a recognition processing unit 230 includes an image recognizing unit 234 and does not include the speech generation section detecting unit. Among elements included in the terminal 201, elements having the same names as those of the terminal 101 have functions that are the same or equivalent to the terminal 101, and thus description thereof will be omitted. In addition, there is an element that may not be included in one of the terminal 101 and the terminal 201, in a case in which the other includes the element. For example, in a case in which the terminal 101 includes a carefulness determining unit, the terminal 201 may not include the carefulness determining unit. The configurations illustrated in FIGS. 2 and 3 represent the elements that are necessary for description of this embodiment, and thus any other element not illustrated therein may be actually included. For example, the recognition processing unit 130 of the terminal 101 may include an image recognizing unit.

Hereinafter, a process of determining whether careful speech is generated by a speaker (carefulness determination) will be described in detail.

[Carefulness Determination Using Voice Recognition]

Collection and voice recognition of speech generated by a speaker are performed using the microphone 111 of the terminal 101, and collection and voice recognition of a voice of speech generated by a speaker are performed using the microphone 211 of the terminal 201 of a listener. Text acquired through voice recognition of the terminal 101 and text acquired through voice recognition of the terminal 201 are compared with each other, and a degree of coincidence of both texts is calculated. In a case in which the degree of coincidence is equal to or higher than a threshold, it is determined that the speaker has generated careful speech, and, in a case in which the degree of coincidence is lower than the threshold, it is determined that careful speech has not been performed.

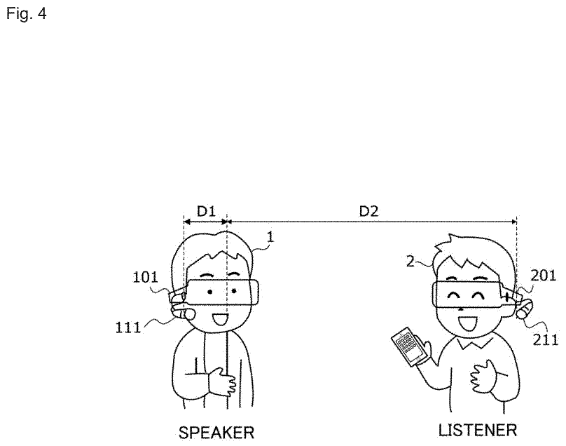

FIG. 4 is a diagram illustrating carefulness determination using voice recognition. Voice utterances of a speaker who is user 1 are collected using the microphone 111, and voice recognition thereon is performed. At the same time, a voice spoken by a speaker is collected on a listener side that is user 2 also using the microphone 211, and voice recognition thereof is performed. A distance D1 between the microphone 111 of the terminal 101 of the speaker and a mouth of the speaker is different from a distance D2 between the microphone 111 and the microphone 211 of the listener. Regardless of the distance D1 and the distance D2 being different from each other, in a case in which a degree of coincidence of text that is results of both voice recognitions is equal to or higher than a threshold, it can be determined that the speaker is generating careful speech. For example, it can be determined that the speaker is generating speech for the listener with a clear and loud voice, good articulation, and an appropriate speed. In addition, it can be determined that the speaker talks while facing the listener side, and a distance to the listener side is appropriate.

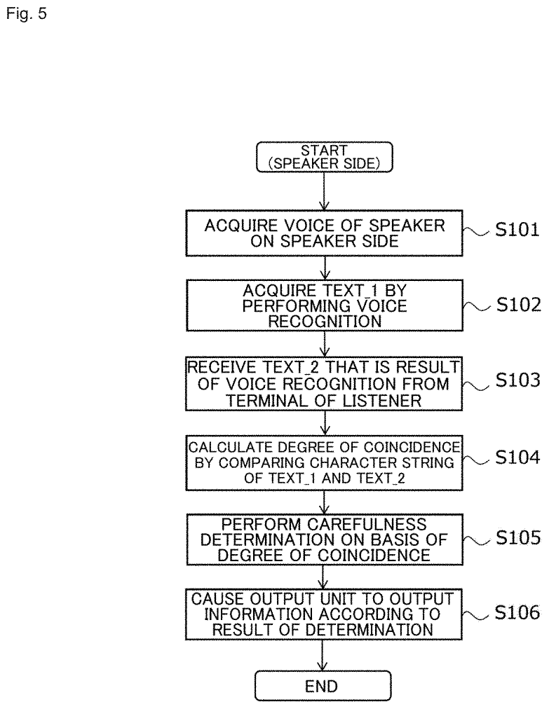

FIG. 5 is a flowchart illustrating an operation example of a terminal 101 of a speaker. In this operation example, a case in which carefulness determination using voice recognition is performed on the terminal 101 side is illustrated.

A voice of a speaker is acquired using the microphone 111 of the terminal 101 (S101). Text (text_1) is acquired by performing voice recognition of the voice using the voice recognition processing unit 131 (S102). The control unit 120 causes the display unit 151 to display text_1 acquired through voice recognition in the display unit 151. Also in the terminal 201 of the listener, voice recognition of a voice of the speaker is performed, and text (text_2) that is a result of the voice recognition in the terminal 201 is acquired. The terminal 101 receives the text_2 from the terminal 201 through the communication unit 140 (S103). By comparing the text_1 with the text_2, the carefulness determining unit 121 calculates a degree of coincidence of both the texts (S104). The carefulness determining unit 121 performs carefulness determination on the basis of the coincidence (S105). In a case in which the degree of coincidence is equal to or higher than a threshold, it is determined that speech generated by the speaker has carefulness, and, in a case in which the degree of coincidence is lower than the threshold, it is determined that speech generated by the speaker does not have carefulness (insufficient carefulness). The output control unit 122 causes the output unit 150 to output information according to a result of the determination acquired by the carefulness determining unit 121 (S106). The information according to the result of determination, for example, includes information for notifying the user 1 of appropriateness/non-appropriateness of a behavior of the speaker at the time of generating speech (presence/absence of carefulness).

For example, in the case of the determination result of no carefulness, an output form of a portion (a text portion) of text displayed in the display unit 151 that corresponds to speech generation that is determined to have no carefulness may be changed. The change of the output form, for example, includes a change of a character font, a color, a size, lighting, and the like. In addition, characters of a corresponding portion may be moved, a size of the characters may be dynamically changed (like an animation), or the like. Alternatively, a message (for example, “there is no carefulness”) representing that there is no careful speech may be displayed in the display unit 151. Alternatively, by vibrating the vibration unit 152 in a predetermined pattern, careful speech being not generated may be notified to the speaker. In addition, the sound output unit 153 may be caused to output a sound or a voice representing that careful speech has not been generated. Text of a portion having no carefulness may be read. In this way, by outputting information according to a determination result indicating no carefulness, a speaker can be prompted to change a speech generation state of a behavior at the time of speech generation to a state in which carefulness is present. For example, the speaker can be prompted to perform a behavior of clearing speech, having the voice to be loud, changing a speech generation speed, facing a listener side, changing a distance to a listener, or the like. A detailed specific example of outputting information according to a determination result of no carefulness will be described below.

In addition, in the case of a determination result that is presence of carefulness, information representing careful speech may not be output to the output unit 150. Alternatively, an output form of a portion (a text portion) of text acquired through voice recognition displayed in the display unit 151 that corresponds to speech determined to be careful may be changed. In addition, by vibrating the vibration unit 152 in a predetermined vibration pattern, presence of careful speech may be notified to the speaker. Furthermore, the sound output unit 153 may be caused to output a sound or a voice representing that careful speech has been generated. In this way, by outputting information corresponding to a determination result that is presence of carefulness, a speaker can determine that speech that can be easily understood by a listener can be continued by maintaining a current speech generation state and be relieved.

Although, although carefulness determination is performed on the terminal 101 side in the operation example illustrated in FIG. 5, a configuration in which the carefulness determination is performed on the terminal 201 side may be also employed.

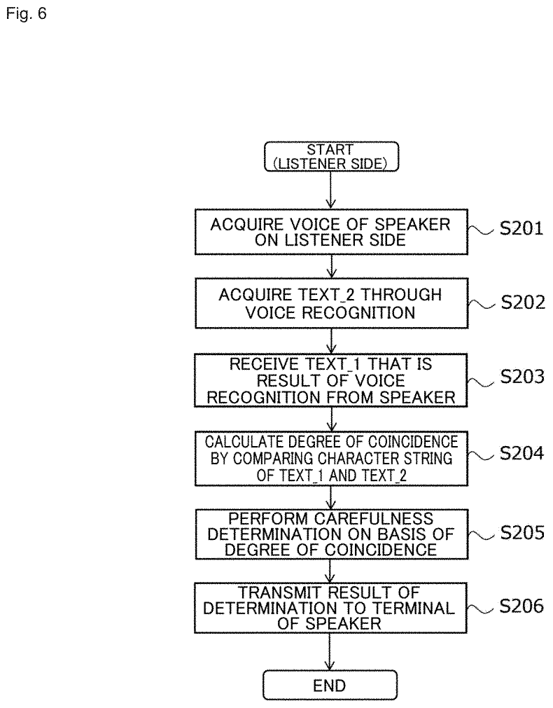

FIG. 6 is a flowchart illustrating an operation example of a case in which carefulness determination is performed on the terminal 201 side.

A voice of a speaker is acquired by the microphone 211 of the terminal 201 (S201). Text (text_2) is acquired by performing voice recognition of the voice using a voice recognition processing unit 231 (S202). Also the terminal 101 of the speaker performs voice recognition of the voice of the speaker, and the terminal 201 receives text (text_1) of the result of the voice recognition in the terminal 101 through the communication unit 240 (S203). A carefulness determining unit 221 compares the text_1 with the text_2 and calculates a degree of coincidence of both the texts (S204). The carefulness determining unit 221 performs carefulness determination on the basis of the degree of coincidence (S205). In a case in which the degree of coincidence is equal to or higher than a threshold, the speech generated by the speaker is determined to have presence of carefulness, and, in a case in which the degree of coincidence is lower than the threshold, the speech of the speaker is determined to have no carefulness. A communication unit 240 transmits information representing the result of the carefulness determination to the terminal 101 of the speaker (S206). An operation of the terminal 101 that has received information representing the result of the carefulness determination is similar to Step S106 illustrated in FIG. 5.

After Step S206, an output control unit 222 of the terminal 201 may cause the output unit 250 to output information according to a result of carefulness determination. For example, in the case of a determination result that is presence of carefulness, a speaker may display a message (for example, “The speaker is careful.”) representing that careful speech is spoken in a display unit 251 of the terminal 201. Alternatively, by vibrating a vibration unit 252 in a predetermined vibration pattern, the speaker may notify a listener that careful speech has been generated. In addition, a speaker may cause a sound output unit 253 to output a sound or a voice representing that careful speech has been generated. In this way, by outputting information according to a determination result that is presence of carefulness, a listener can determine that a speaker maintains a current speech generation state and continues to generate speech that can be easily understood by the listener.

To the contrary, in the case of a determination result that is absence of carefulness, a speaker may display a message (for example, “The speaker is not careful.”) representing that careful speech is not spoken in the display unit 251 of the terminal 201. Alternatively, by vibrating the vibration unit 252 in a predetermined vibration pattern, the speaker may notify a listener that careful speech has not been generated. In addition, a speaker may cause the sound output unit 253 to output a sound or a voice representing that careful speech has not been generated. In this way, by outputting information according to a determination result that is absence of carefulness, a listener can expect a speaker to change a behavior at the time of generating speech to a careful state (the listener knows that the information according to the determination result of absence of carefulness is also presented to the speaker).

In the operation example illustrated in FIG. 6, the terminal 201 may transmit information representing a degree of coincidence of both texts to the terminal 101 without performing Steps S205 and S206. In such a case, the carefulness determining unit 121 of the terminal 101 that has received the information representing the degree of coincidence may perform carefulness determination on the basis of the degree of coincidence (S105 illustrated in FIG. 5).

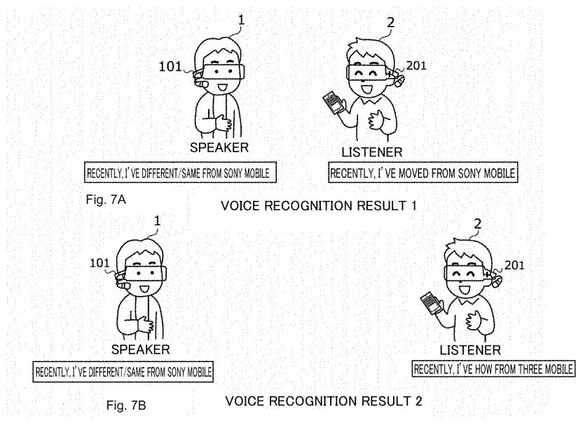

FIG. 7 is a diagram illustrating a specific example in which a degree of coincidence is calculated. FIG. 7(A) illustrates an example of a result of voice recognition of a case in which a distance between a speaker who is user 1 and a listener who is user 2 is short, a volume of speech generated by the speaker is large, and the speaker speaks with good articulation. The result of voice recognition of the speaker is text of 17 characters, and 16 characters among the 17 characters coincide with the result of voice recognition of the listener. Thus, the degree of coincidence is 88% (=16/17). When a threshold is set to 80%, speech generated by the speaker is determined to have carefulness.

FIG. 7(B) illustrates an example of a result of voice recognition of a case in which a distance between a speaker who is user 1 and a listener who is user 2 is long, a volume of speech generated by the speaker is small, and the speaker speaks with bad articulation. The result of voice recognition of the speaker is text of 17 characters, and 10 characters among the 17 characters coincide with the result of voice recognition of the listener. Thus, the degree of coincidence is 58% (=10/17). When a threshold is set to 80%, speech generated by the speaker is determined to have no carefulness.

[Carefulness Determination Using Image Recognition]

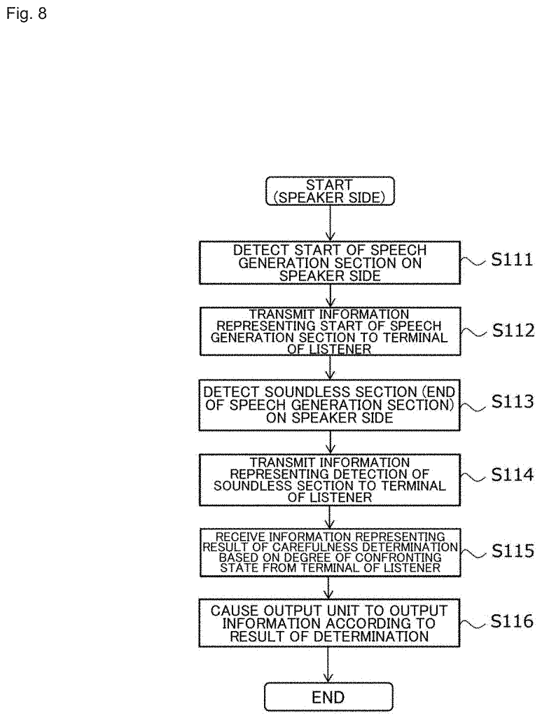

In a time in which speech is generated by a speaker (a speech generation interval), the speaker is imaged by the outward camera 213 of the terminal 201 of the listener. Image recognition of the captured image is performed, and a predetermined portion of the body of the speaker is recognized. Here, although an example in which a mouth is recognized is illustrated, any other portion such as a shape of the eyes, an orientation of the eyes, or the like may be recognized. A time in which the mouth is recognized can be regarded as a time in which the speaker is facing the listener. A control unit 220 (the carefulness determining unit 221) measures a time in which the mouth is recognized and calculates a ratio of a sum of times in which the mouth has been recognized to a speech generation section. The calculated ratio will be regarded as a degree of a confronting state. In a case in which a degree of a confronting state is equal to or higher than a threshold, it is determined that a time in which a speaker is facing a listener is long, and careful speech is generated. In a case in which the degree of the confronting state is lower than the threshold, it is determined that a time in which a speaker is facing a listener is long, and careful speech is not generated. Hereinafter, description will be presented in detail with reference to FIGS. 8 to 10.

FIG. 8 is a flowchart illustrating an operation example of a terminal 101 of a speaker.

A voice of the speaker is acquired by the microphone 111 of the terminal 101, and a voice signal is provided for the recognition processing unit 130. The speech generation section detecting unit 132 of the recognition processing unit 130 detects start of a speech generation section on the basis of the voice signal having an amplitude of a predetermined level or more (S111). The communication unit 140 transmits information representing start of a speech generation section to the terminal 201 of the listener (S112). When an amplitude of lower than a predetermined level continues for a predetermined time, the speech generation section detecting unit 132 detects an end of the speech generation section (S113). In other words, a soundless section is detected. The communication unit 140 transmits information representing detection of a soundless section to the terminal 201 of the listener (S114). The communication unit 140 receives information representing a result of carefulness determination performed on the basis of the degree of a confronting state from the terminal 201 of the listener (S115). The output control unit 122 causes the output unit 150 to output information according to the result of carefulness determination (S116).

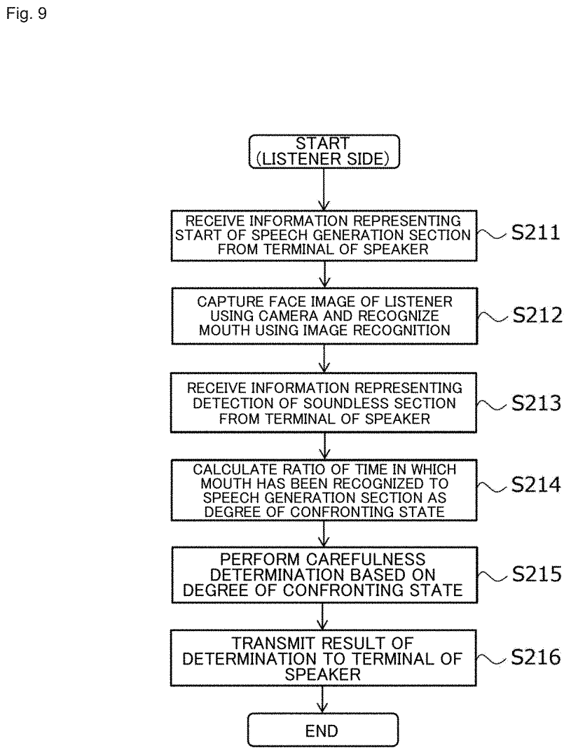

FIG. 9 is a flowchart illustrating an operation example of a terminal 201 of a listener. The terminal 201 of the listener performs an operation corresponding to the terminal 101 performing the operation illustrated in FIG. 8.

The communication unit 240 of the terminal 201 of the listener receives information representing start of a speech generation section from the terminal 101 of the speaker (S211). The control unit 220 images the speaker at a predetermined time interval using the outward camera 213 (S212). The image recognizing unit 234 performs image recognition on the basis of the captured image and performs a process of recognizing a mouth of the speaker. In the image recognition, for example, an arbitrary method such as a semantic segmentation can be used. The image recognizing unit 234 associates information of presence/absence of recognition indicating whether a mouth is recognized with each captured image. The communication unit 240 receives information representing detection of a soundless section from the terminal 101 of the speaker (S213). The carefulness determining unit 221 calculates a ratio of a sum of times in which the mouth is recognized to the speech generation section as a degree of the confronting state on the basis of presence/absence information of recognition associated with a captured image for every predetermined time (S214). The carefulness determining unit 221 performs carefulness determination on the basis of the degree of the confronting state (S215). In a case in which the degree of the confronting state is equal to or higher than a threshold, it is determined that speech generated by the speaker has carefulness, and, in a case in which the degree of the confronting state is lower than the threshold, it is determined that the speech generated by the speaker has no carefulness. The communication unit 240 transmits information representing a result of the determination to the terminal 101 of the speaker (S216).

A part of the process of the flowchart illustrated in FIG. 9 may be performed by the terminal 101 of the speaker. For example, after calculating a sum of the times in which the mouth is recognized in Step S214, the terminal 201 of the listener transmits information representing the calculated time to the terminal 101 of the speaker. The carefulness determining unit 121 of the terminal 101 of the speaker calculates a degree of the confronting state on the basis of the ratio of the times represented by the information in the speech generation section. The carefulness determining unit 121 of the terminal 101 determines that the speech of the speaker has carefulness in a case in which the degree of the confronting state is equal to or higher than a threshold and determines that the speech of the speaker has no carefulness in a case in which the degree of the confronting state is lower than the threshold.

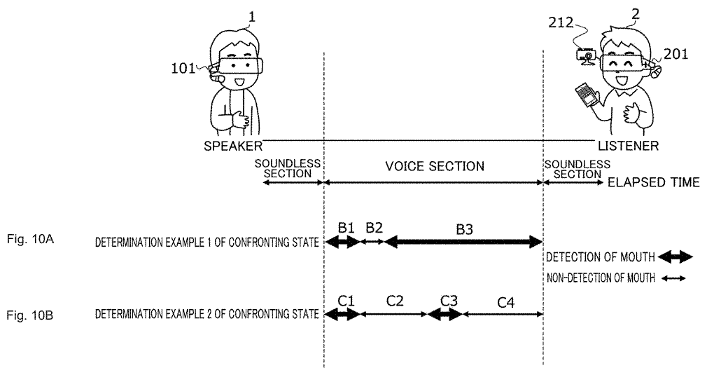

FIG. 10 is a diagram illustrating a specific example in which a degree of a confronting state is calculated. An outward camera 213 included in the terminal 201 of the listener is schematically illustrated. The outward camera 213 may be embedded inside of a frame of smart glasses.

FIG. 10(A) illustrates an example of a case in which a mouth of a speaker is recognized by the terminal 201 of user 2 between times of a predetermined ratio or higher in a speech generation section of the speaker who is user 1. In a voice section in the terminal 201 of the listener, the mouth is recognized in a first sub-section B1, the mouth is not recognized in a subsequent sub-section B2, and the mouth is recognized in the remaining sub-section B3. It is assumed that a length of the voice section is 4 seconds, and a time of a sum of the sub-sections B1 and B3 is 3.6 seconds. At this time, a degree of the confronting state is 90% (=3.6/4). When a threshold is set to 80%, it is determined that the speech generated by the speaker has carefulness.

FIG. 10(B) illustrates an example of a case in which a mouth of a speaker is not recognized by the terminal 201 of user 2 between times of a predetermined ratio or higher in a speech generation section of the speaker who is user 1. In a voice section in the terminal 201 of the listener, the mouth is recognized in a first sub-section C1, the mouth is not recognized in a subsequent sub-section C2, the mouth is recognized in a subsequent sub-section C3, and the mouth is not recognized in the remaining sub-section C4. It is assumed that a length of the voice section is 4 seconds, and a time of a sum of the sub-sections C1 and C3 is 1.6 seconds. At this time, a degree of the confronting state is 40% (=1.6/4). When a threshold is set to 80%, it is determined that the speech generated by the speaker has no carefulness.

[Another Example of Carefulness Determination Using Image Recognition]

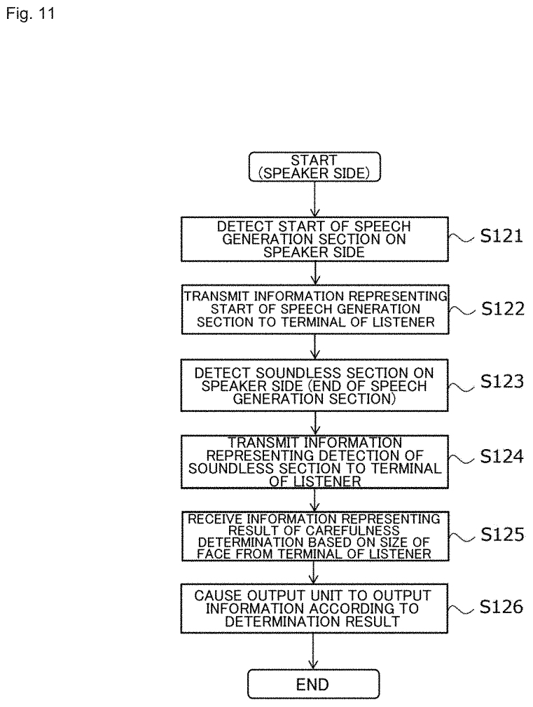

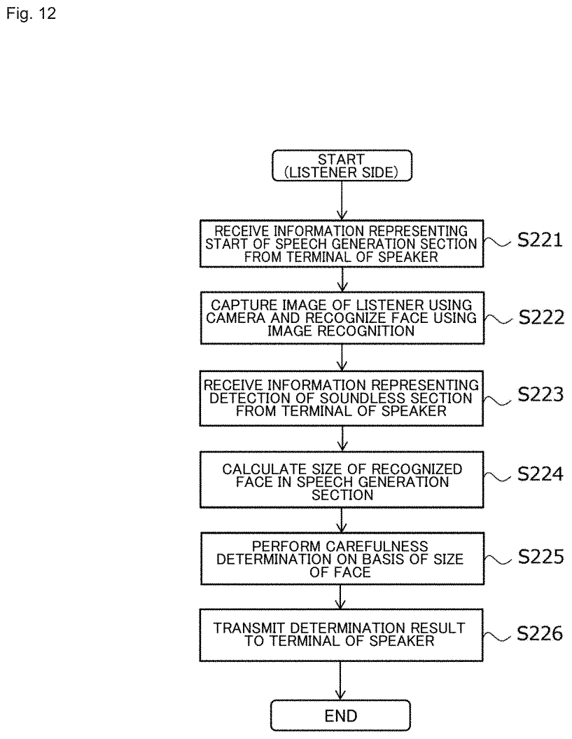

In the description of FIGS. 8 to 10 described above, although it is determined whether a speaker is facing a listener, it may be determined whether a distance between the speaker and the listener is appropriate. In a time (speech generation section) in which a speaker generates speech, a predetermined portion (for example, a face) of a body of the speaker is recognized on the basis of image recognition of an image captured by the outward camera 213 of the terminal 201 of the listener. A size of the recognized face is measured. The size of the face may be an area or may be a length of a predetermined portion. In a case in which the measured size is equal to or larger than a threshold, it is determined that the distance between the speaker and the listener is appropriate, and the speaker has generated careful speech. In a case in which the measured size is smaller than the threshold, it is determined that the distance between the speaker and the listener is too long, and careful speech has not been generated. Hereinafter, description will be presented in detail with reference to FIGS. 11 and 12.

FIG. 11 is a flowchart illustrating an operation example of the terminal 101 of a speaker.

Steps S121 to S124 are the same as Steps S111 to S114 illustrated in FIG. 8. The communication unit 140 of the terminal 101 receives information representing a result of carefulness determination based on the size of a face of a speaker recognized through image recognition from the terminal 201 of a listener (S125). The output control unit 122 causes the output unit 150 to output information according to the result of the carefulness determination (S126).

FIG. 12 is a flowchart illustrating an operation example of the terminal 201 of a listener. The terminal 201 of the listener performs an operation corresponding to the terminal 101 that performs the operation illustrated in FIG. 11.

The communication unit 240 of the terminal 201 of the listener receives information representing start of a speech generation section from the terminal 101 of the speaker (S221). The control unit 220 images the speaker using the outward camera 213 (S222). The image recognizing unit 234 performs image recognition on the basis of the captured image and performs a process of recognizing a face of the speaker (S222). The imaging and the process of recognizing a face may be performed once or may be performed several times at predetermined time intervals. When the communication unit receives information representing detection of a soundless section from the terminal 101 of the speaker (S223), the carefulness determining unit 221 calculates a size of the face recognized in Step S222 (S224). In a case in which the imaging and the process of recognizing a face are performed several times, the size of the face may be a statistical value such as an average value, a maximum size, a minimum size, or the like or may be one size that is arbitrarily selected. The carefulness determining unit 221 performs carefulness determination on the basis of a size of the recognized face (S225). In a case in which the size of the face is equal to or larger than a threshold, it is determined that the speech of the speaker has carefulness, and, in a case in which the size of the face is smaller than the threshold, it is determined that the speech of the speaker has no carefulness. The communication unit 240 transmits information representing a result of the determination to the terminal 101 of the speaker (S226).

A part of the process of the flowchart illustrated in FIG. 12 may be performed by the terminal 101 of the speaker. For example, after calculating the size of the face in Step S224, the terminal 201 of the listener transmits information representing the calculated size to the terminal 101 of the speaker. The carefulness determining unit 121 of the terminal 101 of the speaker determines whether or not there is carefulness in the speech of the speaker on the basis of the size of the face.

In addition, the image recognition may be performed on the terminal 101 side. In such a case, an image recognizing unit is disposed also in the terminal 101, and the image recognizing unit performs image recognition of a face of a listener on the basis of an image of the listener captured by the outward camera 113. The carefulness determining unit 121 of the terminal 101 performs carefulness determination on the basis of the size of the face for which the image recognition has been performed.

In addition, image recognition may be performed by both the terminal 201 of the listener and the terminal 101 of the speaker. In such a case, for example, the carefulness determining unit of the terminal 101 or the terminal 201 may perform carefulness determination on the basis of a statistical value such as an average or the like of sizes of a face calculated by both the parties.

[Carefulness Determination Using Distance Detection]

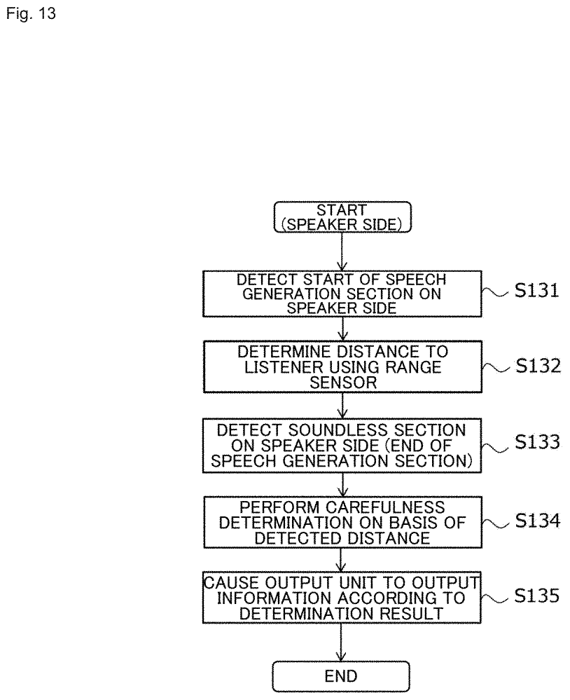

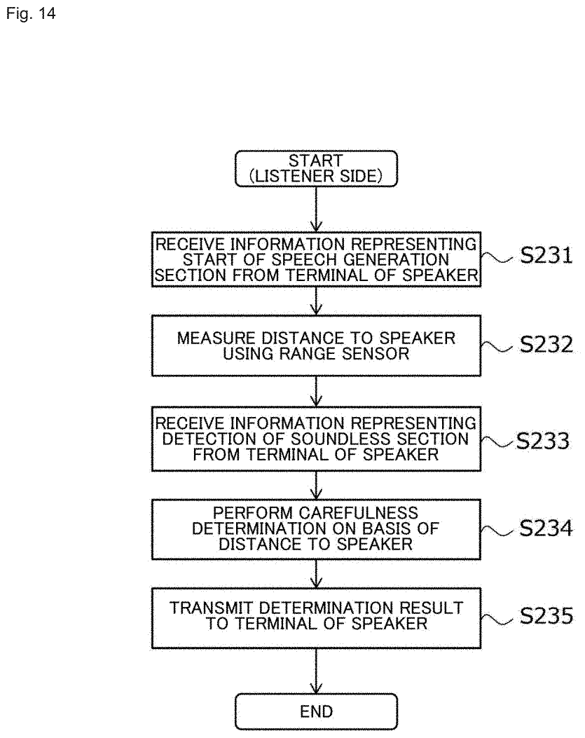

A distance between a speaker and a listener using a range sensor is measured, and it may be determined whether or not the distance between the speaker and the listener is appropriate. In a time in which the speaker is generating speech (a speech generation section), a distance between the speaker and the listener is measured using the range sensor 114 of the terminal 101 of the speaker or the range sensor 214 of the terminal 201 of the listener. In a case in which the measured distance is shorter than a threshold, it is determined that the distance between the speaker and the listener is appropriate, and the speaker is generating careful speech. In a case in which the measured distance is equal to or longer than the threshold, it is determined that the distance between the speaker and the listener is too long, and careful speech is not generated. Hereinafter, description will be presented in detail with reference to FIGS. 13 and 14.

FIG. 13 is a flowchart illustrating an operation example of the terminal 101 of a speaker. In FIG. 13, an operation performed in a case in which distance measurement is performed on the terminal 101 side is illustrated.

The speech generation section detecting unit 132 of the terminal 101 detects start of a speech generation section on the basis of voice signals having amplitudes of a predetermined level or more detected by the microphone 111 (S131). The recognition processing unit 130 measures a distance to the listener using the range sensor 114. For example, an image including distance information is captured, and a distance to a position of the listener recognized in the captured image is detected (S132). Detection of a distance may be performed once or may be performed several times at predetermined time intervals. When an amplitude of less than a predetermined level continues for a predetermined time, the speech generation section detecting unit 132 detects an end of the speech generation section (S133). In other words, a soundless section is detected. The carefulness determining unit 121 performs carefulness determination on the basis of the detected distance (S134). In a case in which the distance to the listener is shorter than a threshold, it is determined that the speech of the speaker has carefulness, and in a case in which the distance to the listener is equal to or longer than the threshold, It is determined that the speech of the speaker has no carefulness. In a case in which distance measurement is performed several times, the distance to a listener may be a statistical value such as an average distance, a maximum distance, or a minimum distance or may be one distance that is arbitrarily set. The output control unit 122 causes the output unit 150 to output information according to a result of the determination (S135).

FIG. 14 is a flowchart illustrating an operation example of a terminal 201 of a listener. FIG. 14 illustrates an operation performed in a case in which distance measurement is performed on the terminal 201 side.

The communication unit 240 of the terminal 201 of the listener receives information representing start of a speech generation section from the terminal 101 of the speaker (S231). The recognition processing unit 230 measures a distance to the speaker using the range sensor 214 (S232). The distance measurement may be performed once or may be performed several times at predetermined time intervals. When the communication unit 240 receives information representing detection of a soundless section from the terminal 101 of the speaker (S233), the carefulness determining unit 221 performs carefulness determination on the basis of the distance to the speaker (S234). In a case in which the distance to the speaker is shorter than a threshold, it is determined that the speech of the speaker has carefulness, and in a case in which the distance to the speaker is equal to or larger than the threshold, it is determined that the speech of the speaker has no carefulness. In a case in which distance measurement is performed several times, the distance to the speaker may be a statistical value such as an average distance, a maximum distance, a minimum distance, or the like or may be one distance that is arbitrary selected. The communication unit 240 transmits information representing a result of the determination to the terminal 101 of the speaker (S235).

The detection of a distance may be performed by both the terminal 201 of the listener and the terminal 101 of the speaker. In such a case, the carefulness determining unit of the terminal 101 or the terminal 201 may perform carefulness determination on the basis of a statistical value such as an average or the like of distances calculated by both the parties.

[Carefulness Determination Using Sound Volume Detection]

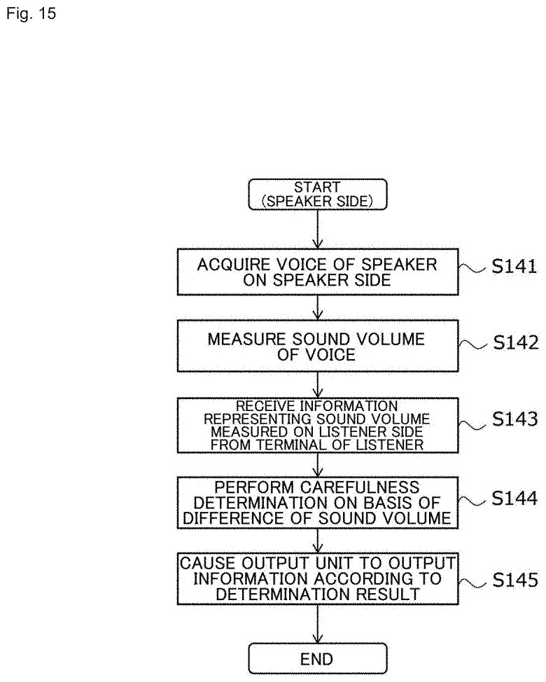

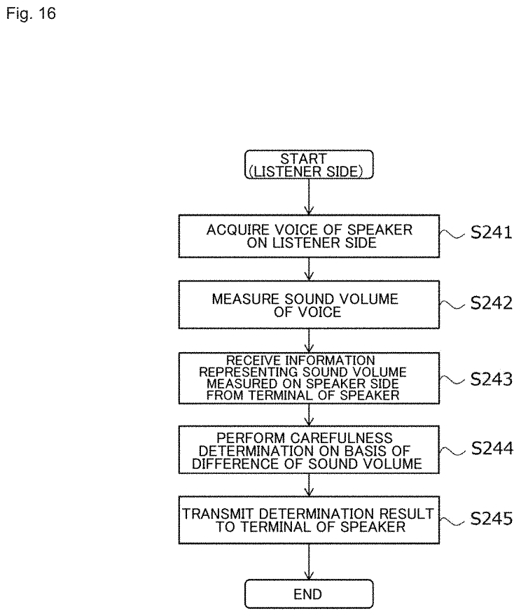

Together with collecting a voice spoken by a speaker using the terminal 101, the voice spoken by the speaker is collected also by the terminal 201 of the listener. A sound volume level of the voice (a signal level of a voice signal) collected by the terminal 101 and a sound volume level of the voice collected by the terminal 201 are compared with each other. In a case in which a difference between both the volume levels is equal to or larger than a threshold, it is determined that the speaker has generated careful speech, and in a case in which the difference is smaller than the threshold, it is determined that careful speech has not been performed. Hereinafter, description will be presented in detail with reference to FIGS. 15 and 16.

FIG. 15 is a flowchart illustrating an operation example of a terminal 101 of a speaker. In this operation example, carefulness determination is performed on the terminal 101 side.

A voice of the speaker is acquired by the microphone 111 of the terminal 101 (S141). The recognition processing unit 130 measures a sound volume of the voice (S142). The sound volume of the voice of the speaker is measured also by the terminal 201 of the listener, and the terminal 101 receives a result of the measurement of the sound volume acquired by the terminal 201 through the communication unit 140 (S143). The carefulness determining unit 121 calculates a difference between the sound volume measured by the terminal 101 and the sound volume measured by the terminal 201 and performs carefulness determination on the basis of the difference between the sound volumes (S144). In a case in which the difference between the sound volumes is smaller than a threshold, it is determined that speech of the speaker has carefulness, and in a case in which the difference between the sound volumes is equal to or larger the threshold, it is determined that the speech of the speaker has no carefulness. The output control unit 122 causes the output unit 150 to output information according to a result of the determination acquired by the carefulness determining unit 121 (S145).

In the operation example illustrated in FIG. 15, although carefulness determination is performed on the terminal 101 side, a configuration in which the carefulness determination is performed on the terminal 201 side can be also employed.

FIG. 16 is a flowchart illustrating an operation example of the terminal 201 of a case in which carefulness determination is performed on the terminal 201 side.

A voice of the speaker is acquired by the microphone 211 of the terminal 201 (S241). The recognition processing unit 230 measures a sound volume of the voice (S242). Sound volume measurement of the voice of the speaker is performed also in the terminal 101 of the speaker, and the terminal 201 receives a result of the sound volume measurement acquired by the terminal 101 through the communication unit 240 (S243). The carefulness determining unit 221 of the terminal 201 calculates a difference between the sound volume measured by the terminal 201 and the sound volume measured by the terminal 101 and performs carefulness determination on the basis of the difference (S244). In a case in which the difference is smaller than a threshold, it is determined that the speech of the speaker has carefulness, and in a case in which the difference is equal to or larger than the threshold, it is determined that the speech of the speaker has no carefulness. The communication unit 240 transmits information representing a result of the carefulness determination to the terminal 101 of the speaker (S245). An operation of the terminal 101 that has received the information representing the result of the carefulness determination is similar to that of Step S145 illustrated in FIG. 15. After Step S245, the output control unit 222 of the terminal 201 may cause the output unit 250 to output information according to the result of the carefulness determination.

[Variation of Output Control at Time when Careful Speech is Determined (Speech Generation Side)]

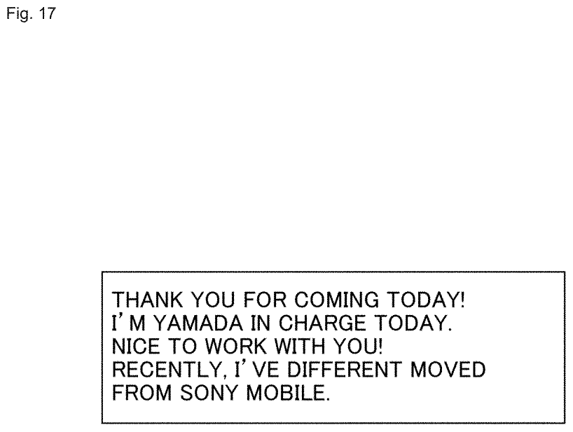

Here, a specific example of information that the output unit 150 is caused to output when the speech of the speaker is determined to be careful speech as a predetermined determination result as a result of the determination of the speech generation will be described in detail. As described above, in a case in which careful speech is determined, information for identifying careful speech may not be output. A display example of a screen of the terminal 101 of the speaker in this case is illustrated in FIG. 17.

FIG. 17 illustrates a display example of a screen of the terminal 101 of a case in which careful speech generation is determined. On the screen, text acquired by performing voice recognition of speech generated by the speaker is displayed. In this example, the speaker generates speech three times. The first speech is “Thank you for coming today!”, the second speech is “I'm Yamada in charge today. Nice to work with you!”, and the third speech is “Recently, I've different moved from Sony Mobile.” When the entire text is regarded as one text, text of each time corresponds to a part of the text. In the example illustrated in FIG. 17, information used for identifying careful speech is not displayed.

Alternatively, information used for identifying careful speech may be displayed. For example, an output form of text corresponding to generated speech determined to have carefulness may be changed (change of a character font, a color, or a size, lighting, blinking, movement of characters, a color/form of the background, change of the color/form of the background, or the like). In addition, by vibrating the vibration unit 152 in a predetermined vibration pattern, generation of careful speech may be notified to the speaker. Furthermore, the sound output unit 153 may be caused to output a sound or a voice that represents generation of careful speech.

[Variation of Output at Time when Non-Careful Speech is Determined (Speech Generation Side)]

Here, a specific example of information that the output unit 150 is caused to output when the speech of the speaker is determined not to be careful speech as a predetermined determination result as a result of the determination of the speech generation will be described.

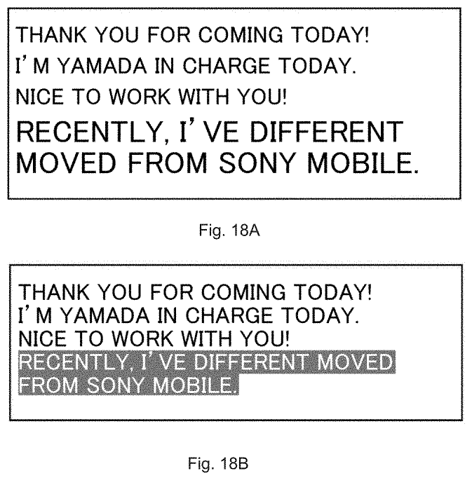

FIG. 18(A) illustrates a display example of a screen of the terminal 101 of a case in which non-careful speech generation is determined. On the screen, text acquired by performing voice recognition of speech generated by the speaker is displayed. “Thank you for coming today!” and “I'm Yamada in charge today. Nice to work with you!” are text corresponding to generated speech determined to have carefulness. “Recently, I've different moved from Sony Mobile.” is text corresponding to generated speech determined to have no carefulness. A size of a character font of the text corresponding to generated speech determined to have no carefulness is increased. Together with the increase in the size of the character font, the color of the character font may be changed. Alternatively, the color of the character font may be changed without changing the size of the character font. By viewing text in which at least one of the size and the color of the character font has been changed, the speaker can easily recognize that careful speech has been generated at the portion of a corresponding text.

FIG. 18(B) illustrates another display example of a screen of the terminal 101 of a case in which non-careful speech generation is determined. A background color of text corresponding to speech generation determined to have no carefulness has been changed. In addition, a color of a character font has been changed. By viewing text in which a background color and a color of the character font have been changed, the speaker can recognize that careful speech has been generated at the portion of corresponding text.

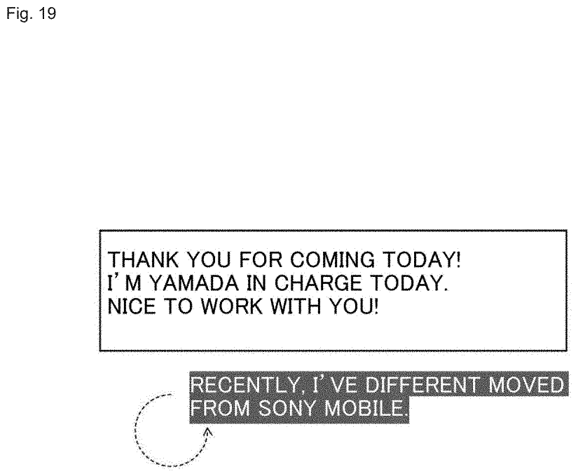

FIG. 19 is a diagram illustrating a further another display example of a screen of the terminal 101 of a case in which non-careful speech generation is determined. Text corresponding to speech generation determined to have no carefulness is continuously moving (like an animation) in a direction represented in an arrowed line of a broken line. Other than the method of continuously moving text, text may be moved using another method such as a method of vibrating the text vertically, horizontally, or in an inclined direction, a method of continuously changing the color, a method of continuously changing the size of the character font, or the like. By viewing text display accompanying movement, the speaker can recognize that careful speech generation is performed at a portion of the corresponding text. An output form other than the example illustrated in FIGS. 18 and 19 can be used. For example, a background (a color, a shape, or the like thereof) of the text may be changed, the text may be decorated, or a display area of the text may be vibrated or transformed (specific examples will be described below). Any other example may be employed.

In the example illustrated in FIGS. 18 and 19, by changing the output form of text displayed in the display unit 151, a portion of text in which no-careful speech generation has been performed is presented to the speaker. As another example, a configuration in which a case in which non-careful speech generation has been performed is notified to the speaker using the vibration unit 152 or the sound output unit 153 can be also employed.

For example, simultaneously with displaying text corresponding to a portion in which non-careful speech generation has been performed in the display unit 151, by operating the vibration unit 152, smart glasses worn by the speaker or a smartphone held by the speaker may be vibrated. A configuration in which the operation of the vibration unit 152 and display of text are not simultaneously performed can be also employed.

In addition, simultaneously with displaying corresponding text in a portion in which non-careful speech generation is performed, the sound output unit 153 may be caused to output a specific sound or voice (sound feedback). For example, the voice synthesizing unit 133 may be caused to generate a synthesis voice signal of “Please talk carefully for a partner!” and output the generated synthesis voice signal from the sound output unit 153 as a voice. The output of the voice synthesis may be performed not simultaneously with display of text.

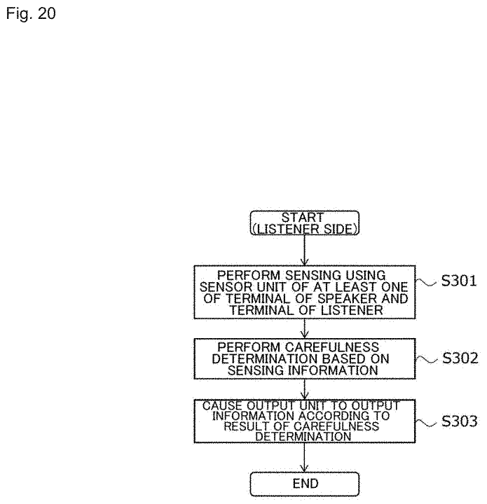

FIG. 20 is a flowchart illustrating the entire operation according to this embodiment. Sensing information of at least one sensor apparatus that senses at least one of a speaker who is a first user and a listener who is a second user communicating with the speaker on the basis of speech generated by the speaker is acquired (S301). As one example, sensing information (first sensing information) acquired by sensing at least one of the speaker and the listener is acquired using at least one sensor apparatus of the terminal 101 of the speaker. Sensing information (second sensing information) acquired by sensing at least one of the speaker and the listener is acquired using at least one sensor apparatus of the terminal 201 of the listener. Examples of the sensing information include various examples described above (a voice signal of speech generated by the speaker, a face image of the speaker, a distance to the partner, and the like). One of the first sensing information and the second sensing information may be acquired, or both thereof may be acquired.

On the basis of the sensing information, the carefulness determining unit of the terminal 101 or the terminal 201 determines whether or not a speaker is generating careful speech (carefulness determination) (S302). For example, on the basis of a degree of coincidence between texts acquired by both the terminals through voice recognition, a ratio of a sum of times in which the mouth of the speaker is recognized in a speech generation section (a degree of the confronting state), a size of a face of the speaker (or the listener) detected on the listener side, a distance between the speaker and the listener, a difference between sound volume levels detected by both the terminals, or the like, determination is performed.

The output control unit 122 of the terminal 101 causes the output unit 150 to output information according to a result of the carefulness determination (S303). For example, in a case in which non-careful speech generation is determined, an output form of text corresponding to the determined speech generation is changed. In addition, by causing the vibration unit 152 to vibrate simultaneously with display of the corresponding text, the sound output unit 153 may be caused to output a sound or a voice simultaneously with display of the corresponding text.

As above, according to this embodiment, on the basis of sensing information of the speaker detected by the sensor unit of at least one of the terminal 101 of the speaker and the terminal 201 of the listener, it is determined whether the speaker is generating careful speech, and information according to a result of the determination is caused to be output to the terminal 101. In accordance with this, the speaker can recognize whether he or she is generating careful speech for the listener, in other words, whether he or she is generating speech that can be easily understood by the listener. Thus, when carefulness is insufficient, the speaker can correct speech generation by himself or herself such that careful speech generation is performed. In accordance with this, it can be prevented that speech generated by the speaker becomes one-sided, and the speech generation progresses in a state in which the speech cannot be understood by the listener, and smooth communication can be realized. The speaker generates speech in a manner of speaking that can be easily understood by the listener, and thus the listener can joyfully continue text communication.

### Second Embodiment

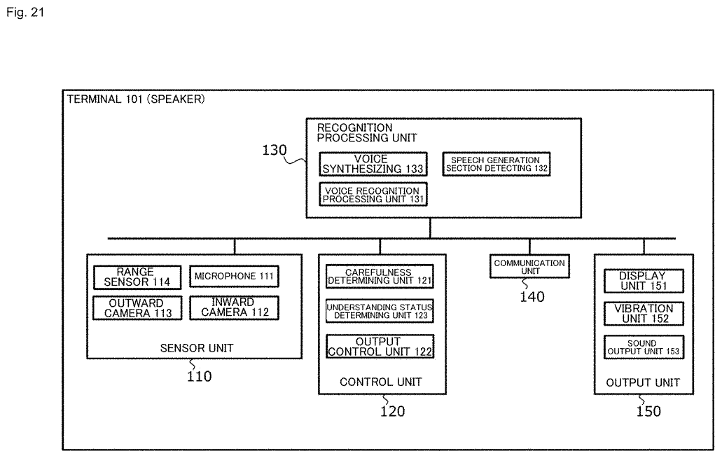

FIG. 21 is block diagram of a terminal 101 including an information processing apparatus of a speaker side according to a second embodiment. An understanding status determining unit 123 is added to the control unit 120 according to the first embodiment. The same reference signs will be assigned to elements of the same names as those illustrated in FIG. 2, and description will be appropriately omitted except for processes that are extended or changed. A configuration in which a carefulness determining unit 121 is not present in a control unit 120 can be also employed.

The understanding status determining unit 123 determines a listener's understanding status for text. As one example, the understanding status determining unit 123 determines a listener's understanding status for text on the basis of a speed at which a listener reads text transmitted to a terminal 201 of the listener. Details of the understanding status determining unit 123 of the terminal 101 will be described below. The control unit 120 (an output control unit 122) controls information that an output unit 150 of the terminal 101 is caused to output in accordance with a listener's understanding status for text.

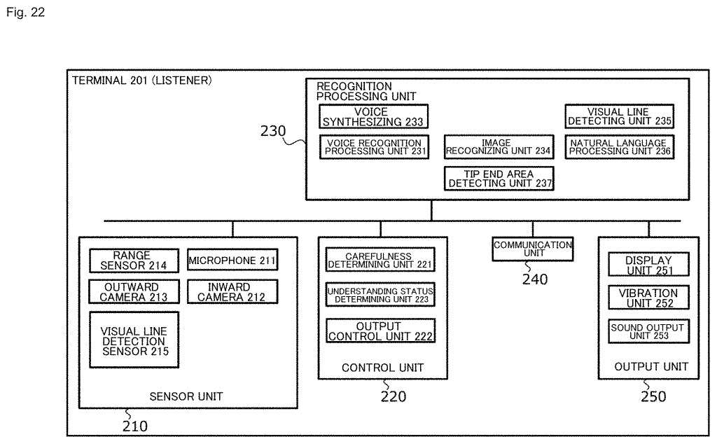

FIG. 22 is a block diagram of a terminal 201 including an information processing apparatus of a listener side. An understanding status determining unit 223 is added to a control unit 220. A visual line detecting unit 235, a natural language processing unit 236, and a tip end area detecting unit 237 are added to a recognition processing unit 230. A visual line detection sensor 215 is added to a sensor unit 210. A configuration in which the carefulness determining unit 221 is not present in the control unit 220 can be also employed. The same reference signs will be assigned to elements of the same names as those illustrated in FIG. 3, and description will be appropriately omitted except for processes that are extended or changed.

The visual line detection sensor 215 detects a visual line of a listener. As one example, the visual line detection sensor 215 includes, for example, an infrared camera and an infrared light emitting element and captures reflective light of the infrared light emitted to the eyes of a listener using the infrared camera.

The visual line detecting unit 235 detects a direction of a visual line of a listener (or a position in a direction parallel to a display surface) using the visual line detection sensor 215. In addition, the visual line detecting unit 235 acquires congestion information (details will be described below) of both eyes of the listener using the visual line detection sensor 215 and calculates a position of a visual line in a depth direction on the basis of the congestion information.

The natural language processing unit 236 performs a natural language analysis of text. For example, a process of identifying a part of speech of a morpheme through a morphological analysis and separating text into phrases on the basis of a result of the morphological analysis and the like are performed.

The tip end area detecting unit 237 detects a tip end area of text. As one example, an area including the last phrase of text is set as a tip end area. An area including the last phrase of text and an area below the phrase in a row disposed one row below may be detected as a tip end area.

The understanding status determining unit 223 determines a listener's understanding status of text. As one example, in a case in which a visual line of a listener stays in a tip end area of text for a predetermined time or more (in a case in which a direction of a visual line is included in the tip end area for a predetermined time or more), it is determined that the listener has completed understanding of the text. In addition, in a case in which the visual line stays at a position that is away from a display area of text by a predetermined distance or more in a depth direction for a predetermined time or more, it is determined that the listener has understood the text. Details of the understanding status determining unit 223 will be described below. By providing information according to a listener's understanding status of text for the terminal 101 using the control unit 220, the terminal 101 acquires a speaker's understanding status and causes the output unit 150 of the terminal 101 to output information according to understanding information.

Hereinafter, a process in which a speaker determines a listener's understanding status (understanding status determination) will be described in detail.

[Determination 1 of Understanding Status Using Detection of Visual Line]

Text acquired by performing voice recognition of speech generated by a speaker is transmitted to the terminal 201 of a listener and is displayed on the screen of the terminal 201. In a case in which a visual line of a listener stays in a tip end area of text for a predetermined time or more, it is determined that understanding of the text has been completed. In other words, it is determined that the listener has finished reading the text.

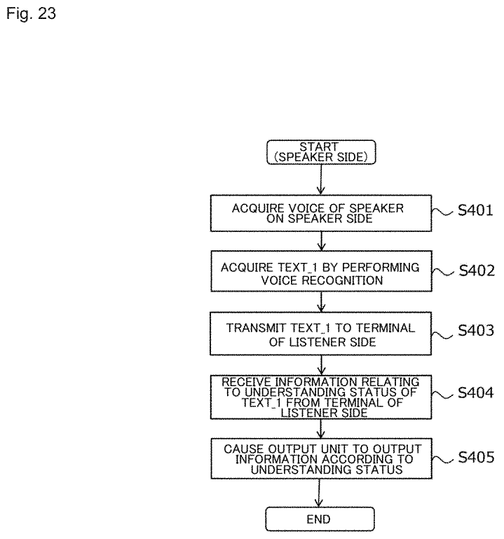

FIG. 23 is a flowchart illustrating an operation example of a terminal 101 of a speaker. A voice of a speaker is acquired by the microphone 111 (S401). Voice recognition of the voice is performed by the voice recognition processing unit 131, whereby text (text_1) is acquired (S402). The communication unit 140 transmits text _1 to the terminal 201 of the listener (S403). The communication unit 140 receives information relating to an understanding status of text_1 from the terminal 201 of the listener (S404). As one example, information representing that the listener has completed (finished reading of) understanding of text_1 is received. As another example, information representing that the listener has not completed understanding of text_1 yet is received. The output control unit 222 causes the output unit 150 to output information according to the listener's understanding status (S405).

For example, in a case in which the information representing that the listener has completed understanding (finished reading) of text_1 is received, a color of a character font, a size, a background color, a shape of the background, and the like of text_1 that has been completed to be understood by the listener may be changed. In addition, a short message representing that listener's understanding has been completed may be displayed near text_1. Furthermore, by operating the vibration unit 152 in a specific pattern or by causing the sound output unit 153 to output a specific sound or a specific voice, listener's completion of understanding of text_1 may be notified to the speaker. After checking listener's completion of understanding of text_1, the speaker may generate next speech. In accordance with this, a speaker is prevented from continuing to generate speech one-sidedly in a status in which speech has not been understood by the listener.

In a case in which information representing that the listener has not completed understanding (finished reading) of text_1 is received, a color of a character font, a size, a background color, a shape of a background, and the like of text_1 of which the listener has not completed understanding may be maintained without changing them or may be changed. In addition, a short message representing that listener's understanding has not been completed may be displayed near text_1. Furthermore, by vibrating the vibration unit 152 in a specific pattern or by causing the sound output unit 153 to output a specific sound or a specific voice, listener's non-completion of understanding of text_1 may be notified to the speaker. When listener's understanding of text_1 has not been completed, the speaker may hold back the next speech. In accordance with this, the speaker can be prevented from continuing speech one-sidedly in a status in which the speech is not understood by a listener.

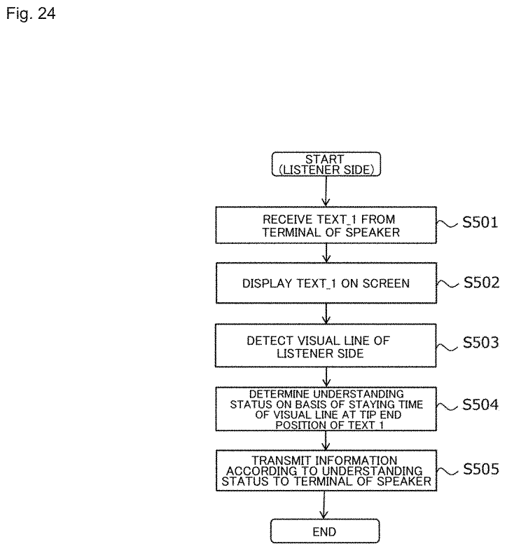

FIG. 24 is a flowchart illustrating an operation example of a terminal 201 of a listener.

The communication unit of the terminal 201 receives text _1 from the terminal 101 of the speaker (S501). The output control unit 222 displays text_1 on the screen of the display unit 251 (S502). The visual line detecting unit 235 detects a visual line of a listener using the visual line detection sensor 215 (S503). The understanding status determining unit 223 determines an understanding status on the basis of a staying time of the visual line for text_1 (S504).

More specifically, an understanding status is determined on the basis of a staying time of a visual line in a tip end area of text_1. When the staying time in the tip end area is equal to or longer than a threshold, it is determined that the listener has completed understanding of text_1. When the staying time is shorter than the threshold, it is determined that the listener has not completed understanding of text_1 yet. The communication unit 240 transmits information according to the speaker's understanding status to the terminal 101 of the speaker (S505). As one example, in a case in which the listener has completed understanding of text_1, information representing that the listener has completed understanding of text_1 is transmitted. In a case in which the listener has not completed understanding text_1, information representing that the listener has not completed understanding of text_1 is transmitted.

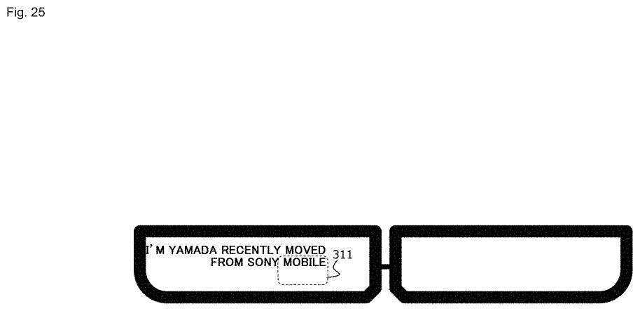

FIG. 25 illustrates a specific example in which an understanding status is determined on the basis of a staying time of a visual line in a tip end area of text. In the display unit 251 of the terminal 201 (smart glasses) of the listener, text received from the terminal 101 of the speaker “I've moved from Sony Mobile and am Yamada.” is displayed. The natural language processing unit 236 of the recognition processing unit 230 of the terminal 201 separates text into phrases through a natural language analysis. The tip end area detecting unit 237 detects an area including the last phrase “am Yamada” and an area below the phrase in a row that is one row below as a tip end area 311 of the text.

The understanding status determining unit 223 acquires information relating to a direction of a visual line of the listener from the visual line detecting unit 235 and detects a sum of times in which the visual line of the listener is included in the tip end area 311 of text or a time in which the visual line is continuously included therein as a staying time. In a case in which the detected staying time is equal to or longer than a threshold, it is determined that a listener's understanding of text has been completed. In a case in which the detected staying time is shorter than the threshold, it is determined that a listener's understanding of text has not been completed. In a case in which it is determined that listener's understanding of text has been completed, the terminal 201 transmits information representing that the listener has completed understanding of the text to the terminal 101. In a case in which it is determined that listener's understanding of text has not been completed, information representing that listener's understanding of the text has not been completed is transmitted to the terminal 101.

[Determination 2 of Understanding Status Using Detection of Visual Line]

Text acquired by performing voice recognition of speech generated by a speaker is transmitted to the terminal 201 of a listener and is displayed on the screen of the terminal 201. The visual line detecting unit 235 of the terminal 201 detects congestion information of the visual line of the listener and calculates a position of the visual line in a depth direction from the congestion information. A relation between congestion information and a position in the depth direction is acquired in advance as correspondence information in the form of a function, a lookup table, or the like. Congestion is movement of eyeballs being drawn to the inner side or open to the outer side when a target is seen using both eyes, and, by using information (congestion information) relating to positions of both eyes, a position of a visual line in the depth direction can be calculated. The understanding status determining unit 223 determines whether the position of the visual line of the listener in the depth direction is within a predetermined distance in the depth direction for a predetermined time or more in an area in which text is displayed (a text User Interface (UI) area). When the position is within the predetermined distance, it is determined that the listener is still reading the text (understanding of the text has not been completed). When the position is outside a predetermined range, it is determined that the listener does not read the text now (understanding of the text has been completed).

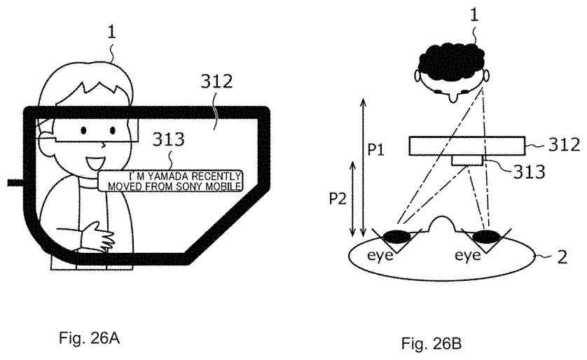

FIG. 26 is a diagram illustrating an example in which a position of a visual line in a depth direction is calculated using congestion information. FIG. 26(A) illustrates a view acquired when a speaker side who is user 1 is seen from a right glass 312 of smart glasses worn by a listener (user 2). In the text UI area 313 of a face of the right glass 312, text acquired by performing voice recognition of speech generated by the speaker is displayed. The speaker is seen over the right glass 312.

FIG. 26(B) illustrates an example in which a position of a visual line of a speaker in a depth direction is calculated in the status illustrated in FIG. 26(A). A position in the depth direction that is acquired when a listener who is user 2 sees a speaker over the right glass 312 (a depth visual line position) is calculated as a position P1 from the congestion information representing positions of both eyes of the listener at this time. In addition, a position in the depth direction acquired when the listener who is user 2 sees the text UI area 313 is calculated from the congestion information representing positions of both eyes of the listener at this time as a position P2.

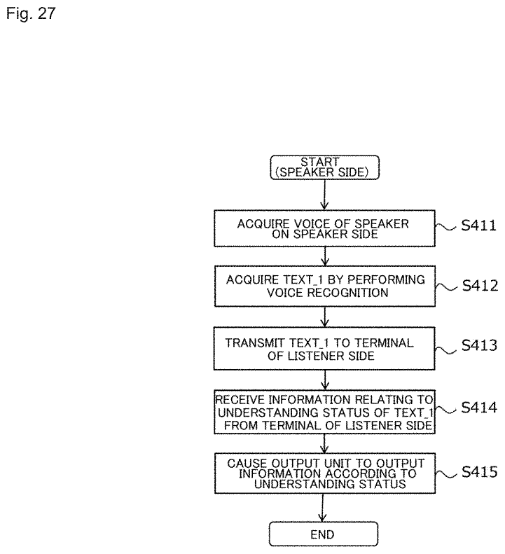

FIG. 27 is a flowchart illustrating an operation example of a terminal 101 of a speaker.

A voice of the speaker is acquired by the microphone 111 (S411). Voice recognition of the voice is performed using the voice recognition processing unit 131, whereby text (text_1) is acquired (S412). The communication unit 140 transmits text _1 to the terminal 201 of the listener (S413). The communication unit 140 receives information relating to an understanding status of text_1 from the terminal of the listener (S414). The output control unit 222 causes the output unit 150 to output information according to the listener's understanding status (S415).

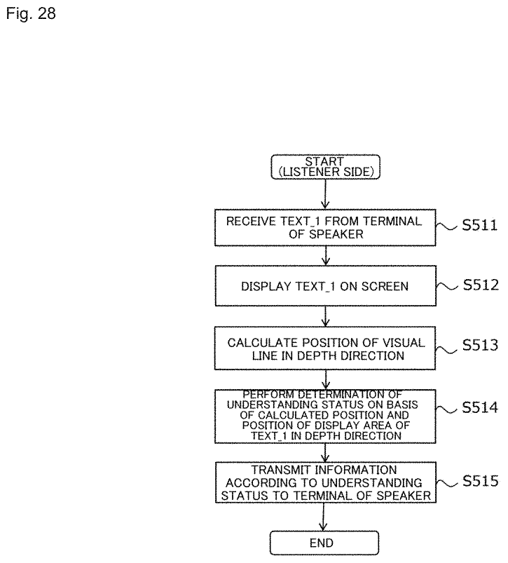

FIG. 28 is a flowchart illustrating an operation example of a terminal 201 of a listener.

The communication unit 240 of the terminal 201 receives text _1 from the terminal 101 of the speaker (S511). The output control unit 222 displays text_1 on the screen of the display unit 251 (S512). The visual line detecting unit 235 acquires congestion information of both eyes of the listener using the visual line detection sensor 215 and calculates a position of a visual line of the listener in the depth direction from the congestion information (S513). The understanding status determining unit 223 determines an understanding status on the basis of a position of the visual line in the depth direction and a position of an area in which text_1 is included in the depth direction (S514). In a case in which the position of the visual line in the depth direction is not included within a predetermined distance with respect to a depth position of the text UI for a predetermined time or more, it is determined that the listener has completed understanding of text_1. In a case in which the position of the visual line in the depth direction is included within a predetermined distance with respect to the depth position of the text UI, it is determined that the listener has not completed understanding of text_1. The communication unit transmits information according to the speaker's understanding status to the terminal 101 of the speaker (S515).

[Determination of Understanding Status Using Speed at Which Person Read Text]

After transmitting text to the terminal 201 of a listener, the understanding status determining unit 123 of the terminal 101 determines an understanding status of the listener on the basis of a speed at which the listener reads characters. The output control unit 122 causes the output unit 150 to output information according to a result of the determination. More specifically, the understanding status determining unit 123 estimates a time required for the listener to understand text from the number of characters of the text transmitted to the terminal 201 of the listener (that is, text displayed in the terminal 201). The time required for understanding corresponding to a time required for reading the entire text. In a case in which a length of a time that has elapsed after text is displayed becomes the time required for the listener to understand the text or longer, the understanding status determining unit 123 determines that the listener has understood the text (has read the entire text). As an output example of the information according to a result of the determination, an output form (a color, a character size, a background color, lighting, blinking, a motion like an animation, or the like) of the text that has been understood by the listener may be changed. Alternatively, the vibration unit 152 may be caused to vibrate in a specific pattern, or the sound output unit 153 may be caused to output a specific sound or voice.

Counting of a time that has elapsed after text is displayed may start from a time point at which the text is transmitted. Alternatively, in consideration of a marginal time until text is displayed after transmission of the text, counting may start from a time point that is a predetermined time after transmission of the text. Alternatively, notification information indicating display of text is received from the terminal 201, and counting may start from a time point at which the notification information has been received.

As the speed at which a listener reads characters, a general speed at the time of a person reading characters (for example, 400 characters per minute or the like) may be used. Alternatively, a speed at which a listener reads characters (a character reading speed) may be acquired in advance, and the acquired speed may be used. In such a case, a character reading speed may be stored in a storage unit of the terminal 101 in association with identification information of a listener for each of a plurality of listeners registered in advance, and a character reading speed corresponding to a listener with whom a conversation is being exchanged may be read from the storage unit.

Determination of a listener's understanding status may be performed for a part of text. For example, portions for which the listener has completed reading text are calculated, and an output form (a color, a character size, a background color, lighting, blinking, a motion like an animation, or the like) of the text up to a portion that has been completed to be read may be changed or the like. In addition, an output form of a portion that is currently being read or a portion text that has not been read may be changed.

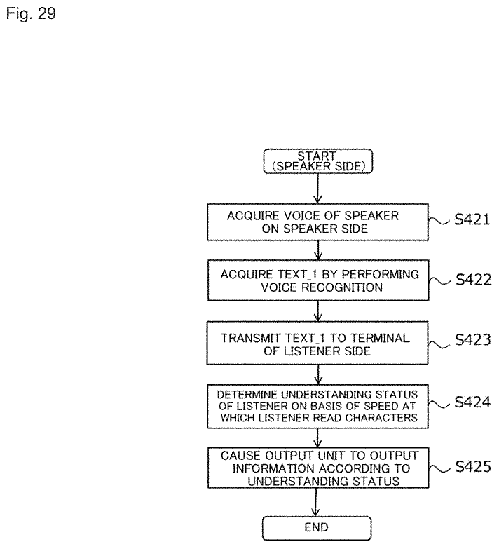

FIG. 29 is a flowchart illustrating an operation example of a terminal 101 of a speaker.

A voice of a speaker is acquired by the microphone 111 (S421). Text (text_1) is acquired by performing voice recognition of the voice using a voice recognition processing unit 131 (S422). The communication unit transmits text_1 to the terminal 201 of the listener (S423). The understanding status determining unit 123 determines a listener's understanding status on the basis of a speed at which the listener reads characters (S424). For example, the understanding status determining unit 123 calculates a time required for the listener's understanding of text from the number of characters of the transmitted text_1. In a case in which the time required for the listener to understand text has elapsed, the understanding status determining unit 123 determines that the listener has understood the text. The determination of a listener's understanding status may be performed for a part of text. The output control unit 122 causes the output unit 150 to output information according to the listener's understanding status (S425). For example, at least one of a portion in which text has been completed to be read (a text portion), a portion that is currently being read (a text portion), and a portion that has not been read (a text portion) is calculated, and an output form of text of the at least one portion is changed.

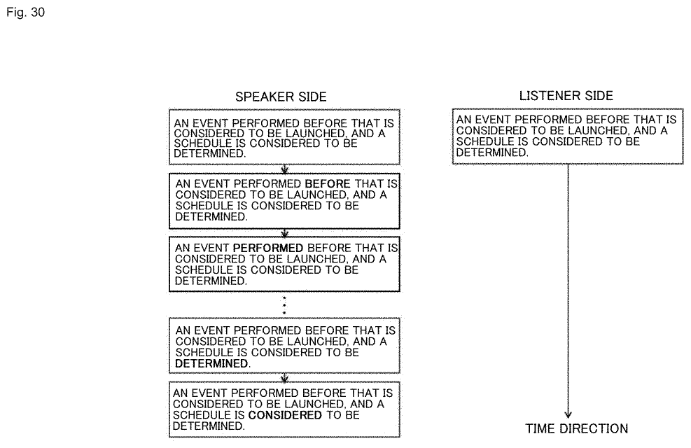

FIG. 30 is a diagram illustrating an example in which an output form of text is changed in accordance with a listener's understanding status. More specifically, for each of a portion that is currently being read by the listener, a portion that has been completed to be read, and a portion that has not been read, the output form is configured to be different. In other words, information identifying each portion (a text portion) is displayed. Text displayed on the speaker side is illustrated on the left side in FIG. 30, and text displayed on the listener side is illustrated on the right side in FIG. 30. The vertical direction is a time direction. When a communication delay is ignored, the text of the speaker side and the text of the listener side are displayed almost simultaneously.

On the speaker side, the entire text that is initially displayed has not been read, and thus the entire text is in the same color (a first color). Immediately after text is displayed, the color of “Before that” that is a first phrase is changed to a second color, and it is identified that this portion is currently being read by the listener. After a time corresponding to 10 characters “Before that” elapses, simultaneously with changing the color of “Before that” to a third color and identifying that this portion has been completed to be read, the color of “it was performed that”, which is the next phrase, is changed to the second color, and it is identified that this portion is currently being read. Similarly, the output form of a corresponding text is partially changed in accordance with time. Such display is controlled by the output control unit 122 of the terminal 101 of the speaker side. In this example, although each portion (text portion) is identified by changing colors of characters, various variations such as change of a background color, change of a size, and the like can be performed.

On the listener side, the displayed text continues to be displayed in the same output form. The output control unit 222 of the terminal 201 of the listener side may erase characters considered to have been read in accordance with elapse of time required for understanding of characters in accordance with a listener's reading speed of characters.

In this way, by controlling the output form of text, after the text is understood by a listener up to the end thereof, the speaker can lead progress to the next speech generation, and thus, a status in which the speaker generates speech one-sidedly is inhibited, and as a result, the speaker can be led to generate careful speech. In addition, the listener may read displayed text at his or her character read speed and thus has a light load. In addition, when a time required for understanding text elapses, characters corresponding to the elapsed time are erased, and thus the listener can easily identify text to be read by him or her.

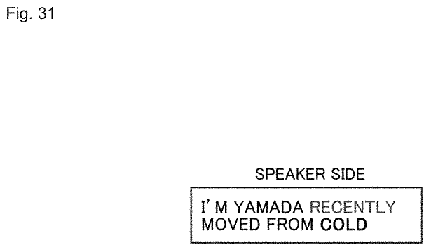

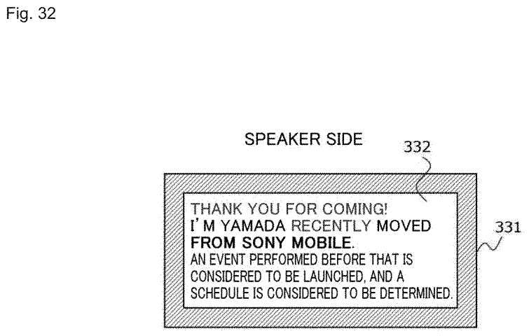

In this way, by changing the output form of text on the speaker side in accordance with a listener's understanding status, there is also an advantage that erroneous recognition of voice recognition can be easily noticed by the speaker. This advantage will be described with reference to FIGS. 31 and 32.

FIG. 31 illustrates an example of text acquired by performing voice recognition of speech generated by a speaker. “Recently” is determined to be completed to be read by a listener and is displayed in a second color. “cold” is determined to be a portion that is being read by the listener and is displayed in the third color. The third color is displayed in a conspicuous color and can be easily noticed by a speaker. “Cold” is a result of erroneous recognition of SOMC”. “SOMC” is an abbreviation of Sony Mobile Communication”. “Cold” is identified in a conspicuous color, and thus the speaker immediately notices the result of the erroneous recognition. In this way, by changing the output form of a text portion in accordance with the understanding status, the speaker is allowed to immediately notice a result of erroneous recognition, and an opportunity for generating speech again can be given to the speaker. In accordance with this, a status in which a result of voice recognition that the listener cannot understand is accumulated is inhibited, and as a result, the speaker can be led to generate speech that can be easily understood.

FIG. 32 is a diagram illustrating another example of text acquired by performing voice recognition of speech generated by a speaker. The text is displayed in a display area 332 inside a display range 331. When the speaker further generates speaker in the state illustrated in FIG. 32, there is not a space for adding text on a lower side any more, and thus text of an uppermost part side is erased (pushed out to the upper side), and text of new voice recognition is added to a row below a lowermost part (“considered to be determined”).

In the example illustrated in FIG. 32, it is determined that listener's understanding has been completed for “Welcome your visiting” and “Recently”, and they are displayed in the second color. In addition, “from Sony Mobile” is a portion that is currently being read and is displayed in the third color. Thus, when the speaker generates next speech at this time point, it can be determined that text acquired through voice recognition of generated speech is added below in a plurality of rows, and a portion that is currently being read and a part thereafter are pushed out to the upper side, the lower side, or the like of the display area 332, and there is a possibility of the text being invisible. If a portion that has not been read by a listener becomes invisible in the display area, the speaker cannot know up to which portion the listener has understood. For this reason, the speaker can hold off the next speech until the portion that the listener has understood further progresses. In accordance with this, it can be inhibited that the speaker sequentially generates speech in a state in which listener's understanding has not been completed, and as a result, careful speech can be led.

[Specific Example of Change of Output Form According to Listener's Understanding Status]

Although there is a partial duplication with the description presented until now, an example of change of an output form of text or a part thereof (a text portion) on the speaker side according to a listener's understanding status will be described more specifically.

In the description presented with reference to FIGS. 30 and 31, an example in which a color is changed as an example of change of the output form for a portion that has been completed to be read by a listener, a portion (a phrase or the like) that is currently being read, and a portion that has not been read has been illustrated. A specific example of changing an output form other than changing of a color is illustrated. Hereinafter, an example in which an output form of a portion that has not been read yet (a portion in an overflown state) is change will be focused in description. However, an output form of a part of a portion that has been completed to be read, a portion that is currently being read, and a portion that has not been read yet (for example, a first phrase in a portion that has not been read or the like) can be changed.

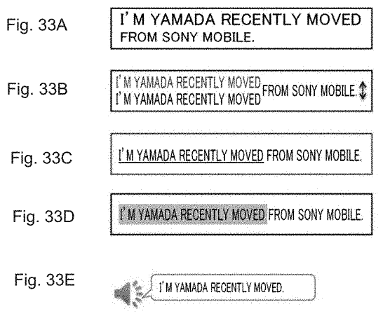

FIG. 33(A) illustrates an example in which a font size of a portion that has not been read yet by a listener is changed. Other than increasing of the font size, the font size can be configured to be decreased. In addition, the font can be configured to be changed to a different kind of font. Instead of a portion that has not been read by the listener, the font size of another portion such as a portion that is currently being read or the like can be configured to be changed.

FIG. 33(B) illustrates an example in which a portion that has not been yet by a listener is moved. In this example, a portion that has not been read yet is repeatedly moved (vibrated) vertically. The portion may be moved in an inclined direction or a horizontal direction. Instead of the portion that has not been read by the listener, another portion such as a portion that is currently being read or the like may be moved.

FIG. 33(C) illustrates an example in which a portion that has not been read yet by a listener is decorated. In this example, although an underline is drawn as the decoration, any other decoration such as writing text in boldface, enclosing text with a rectangle, or the like can be configured to be used. Instead of a portion that has not been read by the listener, another portion such as a portion that is currently being read or the like may be decorated.

FIG. 33(D) illustrates an example in which a background color of a portion that has not been read yet by a listener is changed. Although the shape of the background is a rectangle, the shape may be any other shape such as a triangle, an oval, or the like. Instead of the portion that has not been read by a listener, a background color of another portion such as a portion that is currently being read or the like may be changed.

FIG. 33(E) illustrates an example in which a portion that has not been read yet by a listener is read using voice synthesis through the sound output unit 153 (a speaker). Other than voice synthesis, the portion may be converted into sound information other than a voice, and the sound information may be output through a speaker. For example, a sound source table in which a specific sound is assigned in units of characters, syllable characters (hiragana or the like), phrases, or the like is prepared. A sound corresponding to characters or the like in a portion that has not been read by a listener is specified from the sound source table. Sound information in which specific sounds are aligned in order of characters is generated. The generated sound information is reproduced using a speaker. Instead of a portion that has not been read by a listener, another portion such as a portion that is currently being read or the like may be read using voice synthesis.

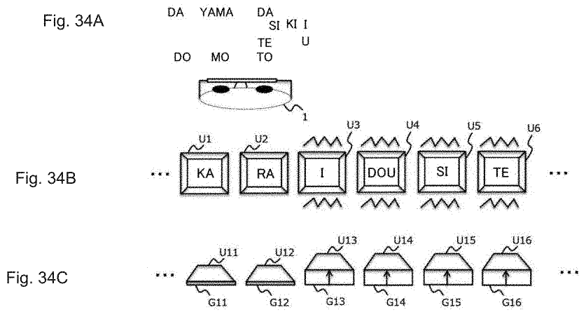

FIG. 34(A) illustrates an example in which sounds corresponding to characters, syllable characters, phrases, or the like included in a portion that has not been read by a listener are mapped into three-dimensional positions and are output.

As an example, syllable characters (hiragana, alphabets, or the like) are associated with different positions inside a space in which a speaker is present. By using sound mapping, a sound is made at a position corresponding to a syllable character included in a portion that has not been read by a listener. In the example illustrated in the drawing, in a space of the circumference of a speaker who is user 1, positions corresponding to syllable characters (hiragana and the like) included in “I'm Yamada moved” are schematically illustrated. Sounds are output at corresponding positions in order of the syllable characters. The output sounds may be reading (pronunciation) of syllable characters or may be sounds of an instrument. When a correspondence between a position and a character can be understood by a speaker, the speaker can perceive a portion (a text portion) hat has not been understood by a listener from a position of the output sound. In the example illustrated in the drawing, although a syllable character is associated with a position, a character (a Chinese character or the like) other than a syllable character may be associated with a position, or a phrase may be associated with a position. Instead of a portion that has not been read by a listener, a sound corresponding to a character or the like included in another portion such as a portion that is currently being read or the like may be mapped into a three-dimensional position and output.

FIG. 34(B) illustrates an example in which a display area of a portion that has not been read by a listener is vibrated. The display unit 151 of the terminal 101 of a speaker includes a plurality of display unit structures, and each display unit structure is configured to be able to mechanically vibrate. For example, a vibration is performed by a vibrator associated with a display unit structure. On the surface of each display unit structure, characters are configured to be able to be displayed using a liquid crystal display element or the like. Control of display using the display unit structures is performed by the output control unit 122, and, in the example of the drawing, as a part of a plurality of display unit structures included in a display area, display unit structures U1, U2, U3, U4, U5, and U6 are illustrated to be planar. On surfaces of the display unit structures U1 to U6, “Ka”, “Ra”, “I” “Do”, “Si”, “Te” are respectively displayed. “I” “Do”, “Si”, “Te” are included in a portion that has not been read by a listener, and thus the output control unit 122 vibrates the display unit structures U3 to U6. “Ka” and “Ra” are portions that have already been completed to be read by the listener, and thus the output control unit 122 do not vibrate the portions. In addition, the display unit structures illustrated in FIG. 34(B) are an example, and an arbitrary structure can be used as long as it includes a structure that vibrates an area in which characters are displayed. Instead of a portion that has not been read by the listener, a display area of another portion such as a portion that is currently being read or the like may be vibrated.

FIG. 34(C) illustrates an example in which a display area of a portion that has not been read by a listener is changed in form. The display unit 151 of the terminal 101 of a speaker includes a plurality of display unit structures, and each display unit structure is configured to be able to mechanically expanded and contracted in a vertical direction with a display area. In the example illustrated in the drawing, as a part of a plurality of display unit structures included in a display area, side faces of display unit structures U11, U12, U13, U14, U15, and U16 are illustrated. The display unit structures U11 to U16 respectively include extending/contracting structures G11 to G16. For example, an extending/contracting scheme may be an arbitrary type such as a slide type. By extending/contracting the extending/contracting structures G1 to G6, a height of a surface of each display unit structure is configured to be changeable. On surfaces of the display unit structures U1 to U6, “Ka”, “Ra”, “I” “Do”, “Si”, “Te” are respectively displayed (not illustrated). “I” “Do”, “Si”, “Te” are included in a portion that has been read by the listener, and thus the output control unit 122 increases heights of the display unit structures U13 to U16. “Ka” and “Ra” are portions that have already been completed to be read by the listener, and thus the output control unit 122 changes the heights of the display unit structures U11 to U12 to a default positions. In addition, the display unit structures illustrated in FIG. 34(B) are an example, and an arbitrary structure can be used as long as it includes a structure that transforms the area in which characters are displayed. In the example illustrated in the drawing, although the plurality of display unit structures are physically independent from each other, the plurality of display unit structures may be integrally configured. A soft display unit such as a flexible organic EL display or the like may be used. In such a case, a display area of each character of the flexible organic EL display corresponds to a display unit structure. The display area may be changed in form by disposing a mechanism that piles up each display area in a convex shape toward the surface side on a rear face of the display and piling up a display area of a character included in a portion that has not been read yet by controlling the mechanism. Instead of the portion that has not been read by the listener, a display area of another portion such as a portion that is currently being read or the like may be changed in form.

### Modified Example 1 of Second Embodiment

In Modified example 1, a scheme that notifies a speaker of being unable to understand text without interrupting speech generation of the speaker at time when details of the displayed text cannot be understood by a listener is provided.

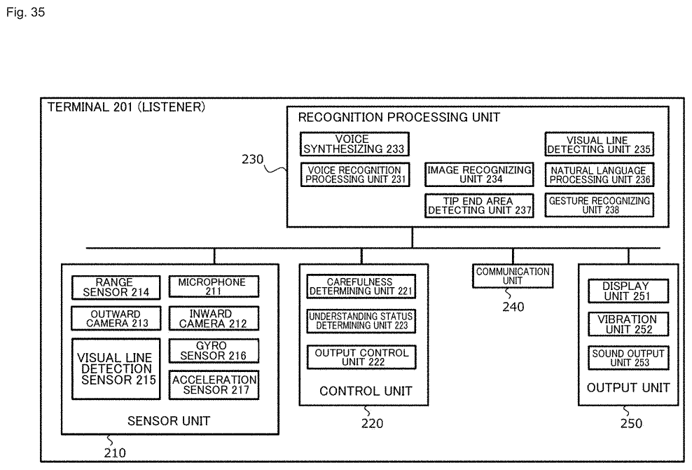

FIG. 35 is a block diagram of a terminal 201 of a listener according to Modified example 1 of the second embodiment. A gesture recognizing unit 238 is added to the recognition processing unit 230 of the terminal 201 according to the second embodiment, and a gyro sensor 216 and an acceleration sensor 217 are added to the sensor unit 210. The block diagram of the terminal 101 of the speaker is the same as that according to the second embodiment.

The gyro sensor 216 detects an angular velocity with respect to a reference shaft. For example, the gyro sensor 216 is a tri-axial gyro sensor. The acceleration sensor 217 detects an angular velocity with respect to the reference shaft. For example, the acceleration sensor 217 is a tri-axial acceleration sensor. By using the gyro sensor 216 and the acceleration sensor 217, a movement direction, orientation, and rotation of the terminal 201 can be detected, and a movement distance and a movement speed can be detected.

The gesture recognizing unit 238 recognizes a gesture of a listener using the gyro sensor 216 and the acceleration sensor 217. For example, the listener puts his or her head to one side. It is detected that the listener has performed a specific operation such as shaking of his or her head, facing of his or her palm upward, or the like. Such an operation corresponds to one example of a behavior performed in a case in which the listener cannot understand details of text. The listener can designate text by performing a predetermined operation.

The understanding status determining unit 223 detects text (a sentence, a phrase, or the like) designated by a listener in text displayed in the display unit 251. For example, when a listener taps text on a display surface of a smartphone, the tapped text is detected. For example, the listener selects text that he or she cannot understand.

As another example, in a case in which a specific operation is recognized by the recognition processing unit 238, the understanding status determining unit 223 detects text that is a target for a gesture (text designated by a listener). The text that is a target for a gesture may be specified using an arbitrary method. For example, the text may be text estimated to be currently being read by a listener. Alternatively, the text may be text in which a direction of a visual line detected by the visual line detecting unit 235 is included. The text may be text that is specified using another method. Text that is currently being read by a listener may be determined on the basis of a listener's reading speed for characters using the method described above or may detect text at which the visual line is positioned using the visual line detecting unit 235.

The understanding status determining unit 223 transmits information for giving a notification of the specified text (incomprehensibility notification) to the terminal 101 of the speaker through the communication unit. The information for giving a notification of text may include a body of the text. Alternatively, in a case in which the specified text is text currently being ready by a listener, and a portion of text that is currently being read by the listener is estimated also on the speaker side, the incomprehensibility notification may be information indicating that the listener is in a status of being unable to understand text. In such a case, the understanding status determining unit 223 of the terminal 101 may estimate text that the listener is reading at a timing at which the incomprehensibility notification is received and determine that the estimated text is text that the listener cannot understand.

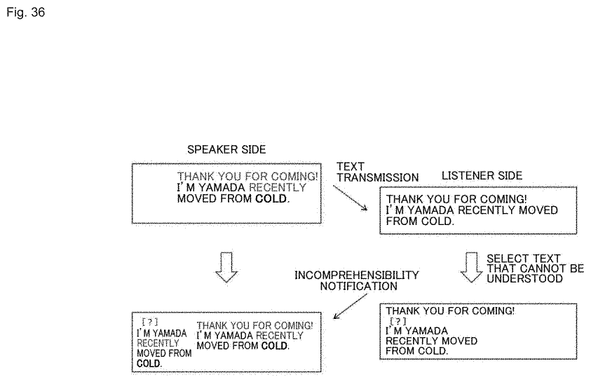

FIG. 36 is a diagram illustrating a specific example in which text that cannot be understood by the listener side is designated, and an incomprehensibility notification of the designated text is transmitted to a speaker side. The speaker generates speech twice, and two pieces of text including “Welcome your visiting!” and “I'm Yamada recently moved from cold” are displayed in the terminal 101 of the speaker. These two pieces of texts are transmitted also to the terminal 201 of the listener in order of speech generation, and the same two pieces of text are displayed also on the listener side. The listener cannot understand “I'm Yamada recently moved from cold!” and thus, for example, touches the corresponding text on the screen. The understanding status determining unit 223 of the terminal 201 of the listener transmits an incomprehensibility notification of the touched text to the terminal 101. In addition, the output control unit 222 of the terminal 201 displays information “[?]” identifying that the listener cannot understand text on the screen in association with the touched text. The understanding status determining unit 123 of the terminal 101 that has received the incomprehensibility notification specifies text that the speaker cannot understand and displays the specified text in association with information “[?]” identifying that the listener cannot understand text on the left side inside the display area. The speaker can see text with which “[?]” is associated and notice that the listener cannot understand this text.

In this way, by notifying the speaker of the text that the listener could not understand, an opportunity for generating speech again can be given to the speaker again. In addition, by only selecting text that cannot be understood, the listener can notify the speaker of the text that he or she cannot understand, and thus speech generation of the speaker is not interrupted.

In the example illustrated in FIG. 36, although text is designated through touch of the screen, as described above, text may be designated through a gesture, or text designated by a listener may be detected through visual line detection. In addition, text designated by a listener is not limited to text that cannot be understood and may be another text such as impressing text, text considered to be important, or the like. In such a case, as information used for identifying impressing text, for example, “sense” may be used. In addition, as information used for identifying text considered to be important, for example, “importance” may be used.

### Modified Example 2

Text acquired through voice recognition is not initially displayed in the terminal 101 of a speaker, and when information for giving a notification of text understood by a listener (a read completion notification) is received from the terminal 201 of the listener, the received text is displayed on the screen of the terminal 101. In accordance with this, the speaker can easily perceive whether details spoken by him or her are understood by the listener and adjust a timing at which next speech is generated. The terminal 201 of the listener may divide text received from the terminal 101 into a plurality of texts and display the divided text (hereinafter, referred to as divisional text) in a stepped manner every time when understanding is completed. Divisional text of which understanding has been completed is transmitted to the terminal 101 every time listener's understanding has been completed. In accordance with this, the speaker can perceive up to where details of speech generated by him or her has been understood by the listener in a stepped manner.

A block diagram of the terminal 201 of the listener according to Modified example 2 is the same as that according to the second embodiment (FIG. 22) or Modified example 1 (FIG. 35). A block diagram of the terminal 101 of the speaker is the same as that according to the second embodiment (FIG. 21).

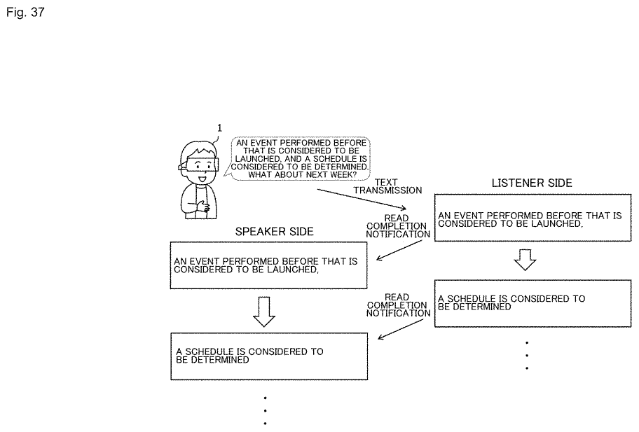

FIG. 37 is a diagram illustrating a specific example of Modified example 2. A speaker who is user 1 generates speech “An event performed before that is considered to be launched, and a schedule is considered to be determined. What about next week?”. The communication unit 140 of the terminal 101 of the speaker transmits text acquired by performing voice recognition of a voice of generated speech to the terminal 201 of a listener. The terminal 201 receives the text from the terminal 101 and divides the text into a plurality of units of which contents can be easily understood using natural language processing.

First, the output control unit 222 displays first divisional text “An event performed before that is considered to be launched” on the screen. The understanding status determining unit 223 detects that the listener has understood the first divisional text through a touch of the screen. For the detection of listener's understanding of divisional text, any other technique described above other than the touch of the screen may be used. For example, there are detection using a visual line (for example, detecting using a tip end area or congestion information) or gesture detection (for example, detection of a nodding operation), and the like. The communication unit transmits a read completion notification including the first divisional text to the terminal 101, and the output control unit 222 displays second divisional text “a schedule is considered to be determined.” on the screen.

The output control unit 122 of the terminal 101 displays the first divisional text included in the read completion notification on the screen of the terminal 101. In accordance with this, the speaker can perceive that the first divisional text has been understood by the listener.

In the terminal 201, the understanding status determining unit 223 detects that the second divisional text has been understood by the listener using a touch on the screen or the like. The communication unit transmits a read completion notification including the second divisional text to the terminal 101, and the output control unit 222 displays divided third divisional text “What about next week?” on the screen.

The output control unit 122 of the terminal 101 displays the second divisional text included in the read end notification on the screen of the terminal 101. In accordance with this, the speaker can perceive that the second divisional text has been understood by the listener. Third divisional text and subsequent divisional text are similarly processed.

In the example illustrated in FIG. 37, although the text is divided using natural language processing, division may be performed using another method such as dividing text in units of a predetermined number of characters or a predetermined number of rows, or the like. In the example illustrated in FIG. 37, although the text is divided and is displayed in a stepped manner, the text may be displayed altogether without dividing the text. In such a case, a read completion notification is transmitted to the terminal 101 in units of texts received from the terminal 101.

According to this Modified Example 2, by displaying only text understood by a listener in the terminal 101 of the speaker, a speaker can easily perceive the text that has been understood by the listener. Thus, until text of details of speech generated by the speaker is initially received from the terminal 201 of the listener side, the speaker can adjust a timing of the next speech generation by holding off the next speech generation or the like. In addition, on the listener side, received text is divided, and next divisional text is displayed every time the divisional text is read, and thus the text can be read at the pace of the listener. New text is not sequentially displayed in a status in which a listener cannot understand text, and thus the listener can proceed to read text with an easy mind.

### Modified Example 3

In Modified example 2 described above, text acquired through voice recognition is not displayed at a time point at which a speaker generates speech, in this Modified example 3, text is displayed at the time of speech generation. When a read completion notification of divisional text is received in the terminal 101 from a listener, an output form (for example, a color) of a portion corresponding to divisional text is changed in displayed text. In a case in which divisional text cannot be understood by the listener side, an incomprehensibility notification is received from the terminal 201, information (for example, “?”) indicating incomprehensibility is displayed in association with relating divisional text. In accordance with this, a speaker can easily perceive up to where contents of speech generated by him or her have been understood by a listener, and divisional text that cannot be understood by the listener can be easily perceived.

A block diagram of the terminal 201 of the listener according to Modified example 3 is the same as that according to the second embodiment (FIG. 22) or Modified example 1 (FIG. 35). A block diagram of the terminal 101 of the speaker is the same as that according to the second embodiment (FIG. 21).

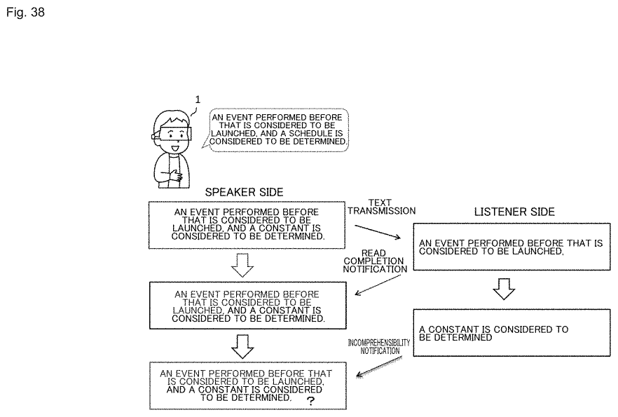

FIG. 38 is a diagram illustrating a specific example of Modified example 3. A speaker who is user 1 generates speech “An event performed before that is considered to be launched, and a schedule is considered to be determined”. Voice recognition of generated speech is performed, and text acquired through the voice recognition is “An event performed before that is considered to be launched, and a constant is considered to be determined”. Here, “constant” is erroneous recognition of “schedule”. This text is displayed on the screen of the terminal 101 and is transmitted to the terminal 201. The terminal 201 receives the text from the terminal 101 and divides the text into a plurality of units of which contents can be easily understood using natural language processing.

First, the output control unit 222 of the terminal 201 displays first divisional text “An event performed before that is considered to be launched” on the screen. The understanding status determining unit 223 detects that the listener has understood the first divisional text through a touch of the screen. For the detection of listener's understanding of divisional text, any other technique described above other than the touch of the screen may be used. For example, there are detection using a visual line (for example, detecting using a tip end area or congestion information) or gesture detection (for example, detection of a nodding operation), and the like. The communication unit 240 of the terminal 201 transmits a read completion notification including the first divisional text to the terminal 101. The output control unit 222 of the terminal 201 displays second divisional text “a constant is considered to be determined.” on the screen of the display unit 251.

The output control unit 122 of the terminal 101 changes a display color of the first divisional text included in the read completion notification. In accordance with this, the speaker can perceive that the first divisional text has been understood by the listener.

In the terminal 201, the understanding status determining unit 223 detects that the listener cannot understand the second divisional text on the basis of a listener's operation of putting his or her head to one side detected using the gesture recognizing unit 238. The communication unit 240 transmits an incomprehensibility notification including the second divisional text to the terminal 101.

The output control unit 122 of the terminal 101 displays the second divisional text included in the incomprehensibility notification on the screen of the terminal 101 in association with information (in this example, “?”) for identifying incomprehensibility. In accordance with this, the speaker can perceive that the second divisional text has not been understood by the listener.

According to this Modified example 3, by changing a color or the like of text that has been understood by a listener in the terminal 101 of the speaker, the speaker can easily perceive the text that has been understood by the listener. Thus, until text of details of speech generated by the speaker is received from the terminal 201 of the listener side, the speaker can adjust a timing of the next speech generation by holding off the next speech generation or the like. In addition, on the listener side, received text is divided, and next divisional text is displayed every time the divisional text is read, and thus the text can be read at the pace of the listener. In addition, divisional text that cannot be understood by the listener can be notified to the speaker using a gesture or the like, and thus speech generation of the speaker is not interrupted.

### Third Embodiment

In a third embodiment, a terminal 101 of a speaker acquires paralanguage information on the basis of a voice signal or the like of speech generated by the speaker. The paralanguage information is information such as an intention, an attitude, a feeling, or the like of a speaker. The terminal 101 decorates text acquired through voice recognition on the basis of the acquired paralanguage information. The decorated text is transmitted to a terminal 201 of a listener. By adding (decorating) information representing an intention, an attitude, and a feeling of a speaker to text acquired through voice recognition, the listener can understand the intention of the speaker more accurately.

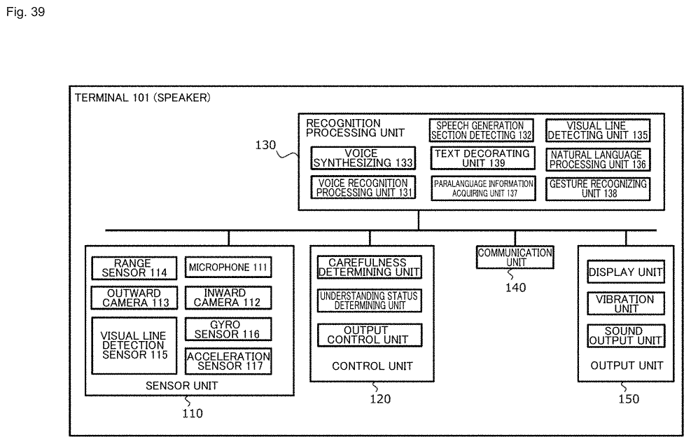

FIG. 39 is a block diagram of a terminal 101 of a speaker according to the third embodiment. A visual line detecting unit 135, a gesture recognizing unit 138, a natural language processing unit 136, a paralanguage information acquiring unit 137, and a text decorating unit 139 are added to a recognition processing unit 130 of the terminal 101, and a visual line detection sensor 115, a gyro sensor 116, and an acceleration sensor 117 are added to a sensor unit. Among the added elements, elements having the same names as those of the terminal 201 described in the second embodiment and the like are the same as those according to the second embodiment and the like, and description thereof will be omitted except for expanded or changed processes. A block diagram of the terminal 201 is the same as that according to the first embodiment, the second embodiment, or Modified examples 1 to 3.

The paralanguage information acquiring unit 137 acquires paralanguage information of a speaker on the basis of a sensing signal acquired by sensing a speaker (user 1) using the sensor unit 110. For example, by performing an acoustic analysis using a neural network that has performed signal processing or learning on the basis of a voice signal acquired by a microphone 111, acoustic feature information representing features of speech generation is generated. As an example of the acoustic feature information, there is an amount of change of a fundamental frequency (pitch) of a voice signal. In addition, there are a frequency of speech generation of each word, a volume of each word, a speech generation speed of each word, and a time interval before and after speech generation of each word included in a voice signal. Furthermore, there is a time length of a soundless section (that is, a time section between generated speeches) included in a voice signal. In addition, there are a spectrum, an excitement, or the like of a voice signal. The examples of the acoustic analysis information described here are only examples, and various kinds of information other than hose can be used. By performing a paralanguage recognizing process on the basis of the acoustic feature information, paralanguage information that is information such as an intention, an attitude, a feeling, and the like of a speaker not included in text of a voice signal is acquired.

For example, an acoustic analysis of a voice signal of text “If you were in the same position, I think you'll do it as well” is performed, and an amount of change of the fundamental frequency is detected. It is determined whether the fundamental frequency (pitch) has been changed by a predetermined value or more for a predetermined time or more at the end of speech generation (whether an end of the word has grown to raise a height of the sound). In a case in which the pitch has risen by a predetermined value or more at the end of speech generation during a predetermined time or more, it is determined that the speaker intended to ask a question. In this case, the paralanguage information acquiring unit 137 generates paralanguage information representing whether the speaker intends to ask a question.

In a case in which the fundamental frequency continues to be the same or be within a predetermined range for a predetermined time or more at the end of speech generation (the height of the sound does not rise, and the end of the word grows), it is determined that the speaker is frank. In this case, the paralanguage information acquiring unit 137 generates paralanguage information representing that the speaker is frank.

In a case in which the frequency rises from a low frequency after start of speech generation (the height of the sound rises in a growl), it is determined that the speaker is impressed, excited, or surprised. In this case, the paralanguage information acquiring unit 137 generates paralanguage information representing that the speaker is impressed, excited, or surprised.

In a case in which there is an interval between speeches, it is determined in accordance with a length of the interval time, whether items are separated (separation), whether speech of an item is omitted (omission), and whether it is an end of speech. For example, in a case in which three items including Curry and Rice, Ramen, and Fried Rice are spoken, when there is an interval that is equal to or longer than a first time and is shorter than a second time between Curry and Rice and Ramen and between Ramen and Fried Rice, the speaker can determine that these three items are enumerated. In this case, the paralanguage information acquiring unit 137 generates paralanguage information representing enumeration of items. In a case in which after there is an interval that is longer than the first time and shorter than the third time after Fried Rice, next speech generation starts, it can be determined that speech generation of an item that can be enumerated after Fried Rice is omitted. In this case, the paralanguage information acquiring unit 137 generates paralanguage information representing omission of an item. In a case in which the speaker has an interval that is equal to or longer than the third time after Fried Rice, it can be determined that the speaker ends speech generation of one sentence (an end of generated speech). In this case, the paralanguage information acquiring unit 137 generates paralanguage information representing the end of speech generation.

When the speaker slowly generates speech of a noun with spaces left before and after the noun, it is determined that the noun is emphasized. In this case, by using the paralanguage information acquiring unit 137, the speaker generates paralanguage information representing being impressed, excited, or surprised.

The paralanguage information can be acquired not from a voice signal but by performing image recognition of a captured signal acquired from the inward camera 112. For example, a shape of a mouth of a person at the time of asking a question is learned in advance, and it may be determined that the speaker intends to ask a question by performing image recognition from an image signal of the speaker. In addition, it may be determined that the speaker intends to ask a question by performing image recognition of a shape of a mouth of user 1. Furthermore, by recognizing an image of a shape of a head of user 1, a time between speeches generated by the speaker (a time in which speech generation is not performed) may be calculated. By performing image recognition of an expression of a face of a speaker, presence/absence of an impression, presence/absence of excitement, and presence/absence of surprise at the time of speech generation may be determined. Other than that, paralanguage information of a speaker may be acquired on the basis of a gesture or a position of a visual line of the speaker. By combining two or more of a voice signal, a captured signal, a gesture, and a position of a visual line, paralanguage information may be acquired. In addition, by measuring biological information using a wearable device that measures a body temperature, a blood pressure, a heart rate, a motion of a body, and the like, paralanguage information may be acquired. For example, in a case in which a heart rate is high, and a blood pressure is high, paralanguage information representing a high degree of tension may be acquired.

The text decorating unit 139 decorates text on the basis of the paralanguage information. The decorating may be performed by assigning a reference sign according to paralanguage information.

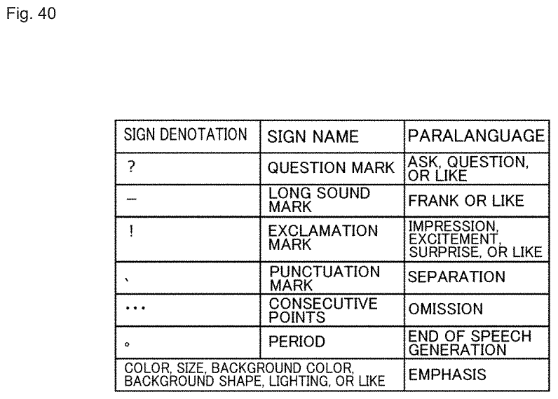

FIG. 40 is a diagram illustrating an example of sign denotations for decorating in accordance with paralanguage information. A table in which a sign denotation and a reference sign name are associated with each other in relation with paralanguage information is illustrated. For example, it represents that, in a case in which the paralanguage information is an ask, a question, or the like, a question mark “?” is used for decorating text.

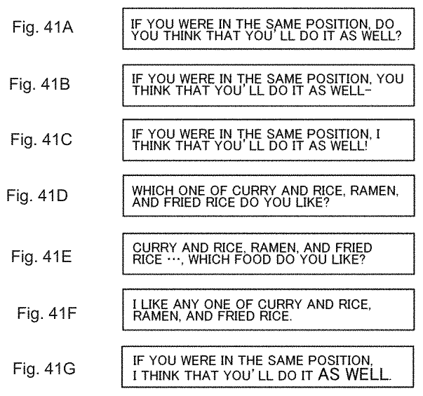

FIG. 41 is a diagram illustrating an example of decorations of text on the basis of the table illustrated in FIG. 40. FIG. 41(A) illustrates an example in which a question mark “?” is added to an end of text in a case in which paralanguage information is an ask, a question, or the like.

FIG. 41(B) illustrates an example in which a long vowel mark “−” is added to an end of text in a case in which paralanguage information represents the state of Frank or the like.

FIG. 41(C) illustrates an example in which an exclamation mark “!” is added to an end of text in a case in which paralanguage information is an impression, excitement, surprise, or the like.

FIG. 41(D) illustrates an example in which a punctation mark “,” is added to a paragraph position in text in a case in which paralanguage information is a paragraph.

FIG. 41(E) illustrates an example in which consecutive points “. . . ” are added to an omission position in a case in which the paralanguage information represents an omission.

FIG. 41(F) illustrates an example in which a period “.” is added to an end of text in a case in which the paralanguage information represents an end of speech generation.

FIG. 41(G) illustrates an example in which, in a case in which the paralanguage information represents emphasis of a noun, a font size of the noun is increased.

### Fourth Embodiment

In the first embodiment to the third embodiment, although a configuration in which the terminal 101 is held by a speaker, and the terminal 201 is held by a listener has been illustrated, the terminal 101 and the terminal 201 may be integrally formed. For example, a digital signage device that is an information processing apparatus having integrated functions of the terminal 101 and the terminal 201 is configured. A speaker and a listener face each other through the digital signage device. The output unit 150, the microphone 111, the inward camera 112, and the like of the terminal 101 are disposed on a screen side of the speaker, and the output unit 250 of the terminal 201, the microphone 211, the inward camera 212, and the like are disposed on a screen of the listener side. Inside the main body, other processing units, storage units, and the like of the terminal 101 and the terminal 201 are disposed.

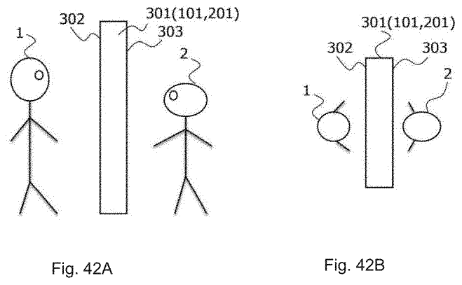

FIG. 42(A) is a side view illustrating an example of a digital signage device 301 in which the terminal 101 and the terminal 201 are integrated. FIG. 42(B) is an upper view of the example of the digital signage device 301.

A speaker who is user 1 generates speech while seeing a screen 302, and text acquired through voice recognition is displayed on a screen 303. A listener who is user 2 sees the screen 303 and checks the text of the speaker that has been acquired through voice recognition and the like. Text acquired through voice recognition is displayed also on the screen 302 of the speaker. In addition, on the screen 302, information according to a result of carefulness determination or information according to listener's understanding information and the like are displayed.

In a case in which a language of the speaker and a language of the listener are different from each other, text acquired through voice recognition of the speaker may be translated into the language of the listener, and the translated text may be displayed on the screen 303. In addition, text input by the listener may be translated into the language of the speaker, and the translated text may be displayed on the screen 302. The input of text from the listener may be performed by performing voice recognition of speech generation of the listener, or text input by the listener using a screen touch or the like may be used. Also in the first to third embodiments described above, text input by the listener may be displayed on the screen of the terminal 101 of the speaker.

### Fifth Embodiment

In the first embodiment to the fourth embodiment, although a form in which the speaker and the listener directly face each other or a form in which they face each other through the digital signage device has been illustrated, a form in which the speaker and the listener remotely communicate with each other cam be employed.

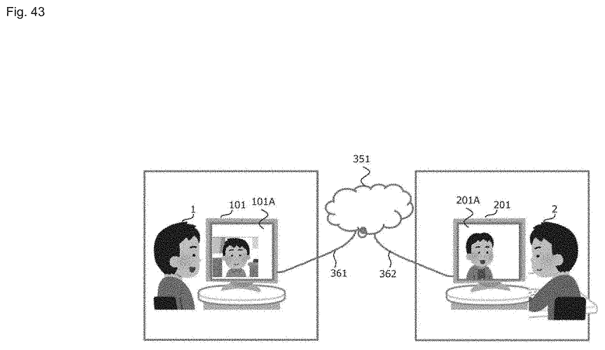

FIG. 43 is a block diagram illustrating a configuration example of an information processing system according to a fifth embodiment. A terminal 101 of a speaker who is user 1 and a terminal 201 of a listener who is user 2 are connected to each other through a communication network 351. The terminal 101 and the terminal 201 are apparatuses such as a PC, a smartphone, a tablet terminal, a TV set, and the like. The communication network 351, for example, include a network such as a cloud or the like, and the terminal 101 and the terminal 201 are connected to the network such as a cloud or the like respectively through access networks 361 and 362. The network such as a cloud or the like, for example, includes a corporate LAN, the Internet, and the like. The access networks 361 and 362, for example, include a 4G or 5G network, a wireless LAN (Wi-Fi), a wired LAN, B1uetooth, and the like.

User 1 (speaker), for example, is present in a place such as a his or her house, a company, a live hall, a reference space, a classroom of a school, or the like. User 2 (listener) is present in a place (for example, a place such as his or her house, a company, a live hall, a conference space, a classroom of a school, or the like) different from that of user 1. On a screen of the terminal 101, an image of user 2 (the listener) received through the communication network 351 is displayed. On a screen of the terminal 201, an image of user 1 (the speaker) received through the communication network 351 is displayed.

User 1 (the speaker) can recognize an appearance of user 2 (the listener) through the screen 101A of the terminal 101. The user 2 (the listener) can recognize an appearance of user 1 (the speaker) through the screen 201A of the terminal 201. User 1 (the speaker) generates speech while seeing the appearance of the listener and the like displayed on the screen 201A of the terminal 201. On both the screen 101A of the terminal 101 that user 1 (the speaker) is seeing and the screen 201A of the terminal 201 that user 2 (the listener) is seeing, text acquired through voice recognition is displayed. User 2 (the listener) sees the screen 201A of the terminal 201 and checks text acquired through voice recognition of user 1 (the speaker) and the like. In addition, on the screen 101A of the terminal 101, information according to a result of carefulness determination or information according to a listener's understanding status and the like are displayed.

(Hardware Configuration)

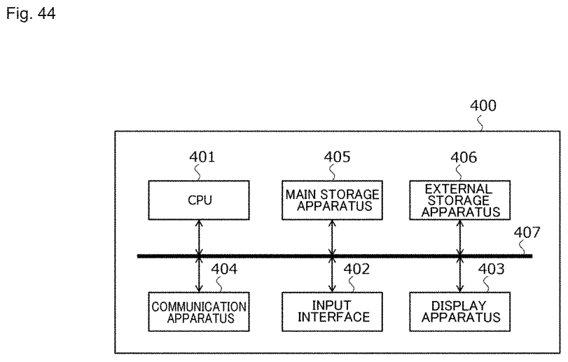

FIG. 44 illustrates an example of the hardware configuration of an information processing apparatus included in the terminal 101 of the speaker or an information processing apparatus included in the terminal 201 of the listener. The information processing apparatus is configured using a computer apparatus 400. The computer apparatus 400 includes a CPU 401, an input interface 402, a display apparatus 403, a communication apparatus 404, a main storage apparatus 405, and an external storage apparatus 406, and these are connected to each other using a bus 407. As one example, the computer apparatus 400 is configured as a smartphone, a tablet, a desktop personal computer (PC), or a notebook PC.

The CPU (central processing unit) 401 executes an information processing program that is a computer program on the main storage apparatus 405. The information processing program is a program that realizes each functional configuration described above of the information processing apparatus. The information processing program may be realized not by one program but by a plurality of programs or a combination of scripts. By the CPU 401 executing the information processing program, each functional configuration is realized.

The input interface 402 is a circuit for inputting an operation signal from an input apparatus such as a keyboard, a mouse, or a touch panel to the information processing apparatus.

The display apparatus 403 displays data output from the information processing apparatus. The display apparatus 403, for example, is a liquid crystal display (LCD), an organic electroluminescence display, a CRT (a brown tube), or a plasma display (PDP) and is not limited thereto. Data output from the computer apparatus 400 can be displayed in the display apparatus 403 thereof.

The communication apparatus 404 is a circuit used by the information processing apparatus to communicate with external apparatuses in a wireless or wired manner. Data can be input from an external apparatus through the communication apparatus 404. Data input from an external apparatus may be stored in the main storage apparatus 405 or the external storage apparatus 406.

The main storage apparatus 405 stores an information processing program, data necessary for executing the information processing program, data generated by executing the information processing program, and the like. The information processing program is expanded and executed on the main storage apparatus 405. Examples of the main storage apparatus 405 include, but are not limited to, a RAM, a DRAM, and an SRAM.

The external storage apparatus 406 stores an information processing program, data necessary for executing the information processing program, data generated by executing the information processing program, and the like. The information processing program and the data are read into the main storage apparatus 405 at the time of executing the information processing program. Examples of the external storage apparatus 406 include, but are not limited to, a hard disk, an optical disk, a flash memory, and a magnetic tape.

The information processing program may be installed in the computer apparatus 400 in advance or stored in a recording medium such as a CD-ROM. In addition, the information processing program may be uploaded to the Internet.

In addition, the information processing apparatus 101 may be constituted of a single computer apparatus 400 or configured as a system made up of a plurality of computer apparatuses 400 being connected to each other.

It should be noted that the above-described embodiments show examples for embodying the present disclosure, and the present disclosure can be implemented in various other forms. For example, various modifications, substitutions, omissions, or combinations thereof are possible without departing from the gist of the present disclosure. Such forms of modifications, substitutions, and omissions are included in the scope of the invention described in the claims and the scope of equivalence thereof, as included in the scope of the present disclosure.

In addition, the effects of the present disclosure described herein are merely exemplary and may have other effects.

The present disclosure may have the following configuration.

[Item 1]

An information processing apparatus including a control unit configured to: determine speech generated by a first user on the basis of sensing information of at least one sensor apparatus sensing at least one of the first user and a second user communicating with the first user on the basis of the speech generation of the first user; and control information output to the first user on the basis of a result of the determination of the speech generation of the first user.

[Item 2]

The information processing apparatus according to Item 1, in which the sensing information includes a first voice signal of the first user sensed using the sensor apparatus of a first user side and a second voice signal of the first user sensed using the sensor apparatus of a second user side, and the control unit determines the speech generation on the basis of comparison between first text acquired by performing voice recognition of the first voice signal and second text acquired by performing voice recognition of the second voice signal.

[Item 3]

The information processing apparatus according to Item 1 or 2, in which the sensing information includes a first voice signal of the first user sensed using the sensor apparatus of a first user side and a second voice signal of the first user sensed using the sensor apparatus of a second user side, and the control unit determines the speech generation on the basis of comparison between a signal level of the first voice signal and a signal level of the second voice signal.

[Item 4]

The information processing apparatus according to any one of Items 1 to 3, in which the sensing information includes distance information between the first user and the second user, and the control unit determines the speech generation on the basis of the distance information.

[Item 5]

The information processing apparatus according to any one of Items 1 to 4, in which the sensing information includes an image of at least a part of a body of the first user or the second user, and the control unit determines the speech generation on the basis of a size of the image of the part of the body included in the image.

[Item 6]

The information processing apparatus according to any one of Items 1 to 5, in which the sensing information includes an image of at least a part of a body of the first user, and the control unit determines the speech generation in accordance with a length of a time in which a predetermined part of the body of the first user is included in the image.

[Item 7]

The information processing apparatus according to any one of Items 1 to 6, in which the sensing information includes a voice signal of the first user, and the control unit is configured to: cause a display apparatus to display text acquired by voice recognition of the voice signal of the first user; and cause the display apparatus to display information for identifying a text portion for which the determination of the speech generation in the text displayed in the display apparatus is a predetermined determination result.

[Item 8]

The information processing apparatus according to Item 7, in which the determination of the speech generation is determination of whether the speech generation of the first user is careful speech generation for the second user, and the predetermined determination result is a determination result representing that the speech generation of the first user is not careful speech generation for the second user.

[Item 9]

The information processing apparatus according to Item 7 or 8, in which, as the information for identifying the text portion, a color of the text portion is changed, a size of characters of the text portion is changed, a background of the text portion is changed, the text portion is decorated, the text portion is moved, the text portion is vibrated, a display area of the text portion is vibrated, or a display area of the text portion is transformed by the control unit.

[Item 10]

The information processing apparatus according to any one of Items 1 to 9, in which the sensing information includes a first voice signal of the first user, the control unit causes a display apparatus to display text acquired by performing voice recognition of the voice signal of the first user, the information processing apparatus further including a communication unit configured to transmit the text to a terminal apparatus of the second user, and the control unit acquires information relating to an understanding status of the second user for the text from the terminal apparatus and controls information output to the first user in accordance with the understanding status of the second user.

[Item 11]

The information processing apparatus according to Item 10, in which the information relating to the understanding status includes information relating to whether or not the second user has completed reading the text, information relating to a text portion of the text of which reading by the second user has been completed, information relating to a text portion of the text that is currently being read by the second user, or information relating to a text portion of the text that has not been read by the second user.

[Item 12]

The information processing apparatus according to Item 11, in which the control unit acquires the information relating to whether or not the text has been completed to be read on the basis of a direction of a visual line of the second user.

[Item 13]

The information processing apparatus according to Item 11, in which the control unit acquires the information relating to whether or the text has been completed to be read by the second user on the basis of a position of the visual line of the second user in a depth direction.

[Item 14]

The information processing apparatus according to Item 11, in which the control unit acquires the information relating to the text portion on the basis of a speed at which the second user reads characters.

[Item 15]

The information processing apparatus according to any one of Items 11 to 15, in which the control unit causes the display apparatus to display information for identifying the text portion.

[Item 16]

The information processing apparatus according to Item 15, in which the control unit, as the information for identifying the text portion, changes a color of the text portion, changes a size of characters of the text portion, changes a background of the text portion, decorates the text portion, moves the text portion, vibrates the text portion, vibrates a display area of the text portion, or transforms the display area of the text portion.

[Item 17]

The information processing apparatus according to any one of Items 1 to 16, in which the sensing information includes a voice signal of the first user, the control unit is configured to cause a display apparatus to display text acquired by voice recognition of the voice signal of the first user, the information processing apparatus further including a communication unit configured to transmit the text to a terminal apparatus of the second user, the communication unit receives a text portion of the text that is designated by the second user, and the control unit causes the display apparatus to display information for identifying the text portion received by the communication unit.

[Item 18]

The information processing apparatus according to any one of Items 1 to 17, further including: a paralanguage information acquiring unit configured to acquire paralanguage information of the first user on the basis of the sensing information acquired by sensing the first user; a text decorating unit configured to decorate text acquired by performing voice recognition of a voice signal of the first user on the basis of the paralanguage information; and a communication unit configured to transmit the decorated text to a terminal apparatus of the second user.

[Item 19]

An information processing method including: determining speech generated by a first user on the basis of sensing information of at least one sensor apparatus sensing at least one of the first user and a second user communicating with the first user on the basis of the speech generation of the first user; and controlling information output to the first user on the basis of a result of the determination of the speech generation of the first user.

[Item 20]

A computer program causing a computer to execute: a step of determining speech generated by a first user on the basis of sensing information of at least one sensor apparatus sensing at least one of the first user and a second user communicating with the first user on the basis of the speech generation of the first user; and a step of controlling information output to the first user on the basis of a result of the determination of the speech generation of the first user.

### REFERENCE SIGNS LIST

1 User

2 User

101 Terminal

101 Information processing apparatus

110 Sensor unit

111 Microphone

112 Inward camera

113 Outward camera

114 Range sensor

115 Visual line detection sensor

116 Gyro sensor

117 Acceleration sensor

120 Control unit

121 Determination unit

122 Output control unit

123 Understanding status determining unit

130 Recognition processing unit

131 Voice recognition processing unit

132 Speech generation section detecting unit

133 Voice synthesizing unit

135 Visual line detecting unit

136 Natural language processing unit

137 Paralanguage information acquiring unit

138 Gesture recognizing unit

139 Text decorating unit

140 Communication unit

150 Output unit

151 Display unit

152 Vibration unit

153 Sound output unit

201 Terminal

201A Smart glasses

201B Smartphone

210 Sensor unit

211 Microphone

212 Inward camera

213 Outward camera

214 Range sensor

215 Visual line detection sensor

216 Gyro sensor

217 Acceleration sensor

220 Control unit

221 Determination unit

222 Output control unit

223 Understanding status determining unit

230 Recognition processing unit

231 Voice recognition processing unit

234 Image recognizing unit

235 Visual line detecting unit

236 Natural language processing unit

237 Tip end area detecting unit

238 Gesture recognizing unit

240 Communication unit

250 Output unit

251 Display unit

252 Vibration unit

253 Sound output unit

301 Digital signage device

302 Screen

303 Screen

311 Tip end area

312 Right glass

313 Text UI area

331 Display range

332 Display area

400 Computer apparatus

402 Input interface

403 Display apparatus

404 Communication apparatus

405 Main storage apparatus

406 External storage apparatus

407 Bus

1. An information processing apparatus comprising a control unit configured to:
determine speech generated by a first user on the basis of sensing information of at least one sensor apparatus sensing at least one of the first user and a second user communicating with the first user on the basis of the speech generation of the first user; and
control information output to the first user on the basis of a result of the determination of the speech generation of the first user.

2. The information processing apparatus according to claim 1,
wherein the sensing information includes a first voice signal of the first user sensed using the sensor apparatus of a first user side and a second voice signal of the first user sensed using the sensor apparatus of a second user side, and wherein the control unit determines the speech generation on the basis of comparison between first text acquired by performing voice recognition of the first voice signal and second text acquired by performing voice recognition of the second voice signal.

3. The information processing apparatus according to claim 1,
wherein the sensing information includes a first voice signal of the first user sensed using the sensor apparatus of a first user side and a second voice signal of the first user sensed using the sensor apparatus of a second user side, and wherein the control unit determines the speech generation on the basis of comparison between a signal level of the first voice signal and a signal level of the second voice signal.

4. The information processing apparatus according to claim 1,
wherein the sensing information includes distance information between the first user and the second user, and
wherein the control unit determines the speech generation on the basis of the distance information.

5. The information processing apparatus according to claim 1,
wherein the sensing information includes an image of at least a part of a body of the first user or the second user, and
wherein the control unit determines the speech generation on the basis of a size of the image of the part of the body included in the image.

6. The information processing apparatus according to claim 1,
wherein the sensing information includes an image of at least a part of a body of the first user, and
wherein the control unit determines the speech generation in accordance with a length of a time in which a predetermined part of the body of the first user is included in the image.

7. The information processing apparatus according to claim 1,
wherein the sensing information includes a voice signal of the first user, and wherein the control unit is configured to:
cause a display apparatus to display text acquired by voice recognition of the voice signal of the first user; and
cause the display apparatus to display information for identifying a text portion for which the determination of the speech generation in the text displayed in the display apparatus is a predetermined determination result.

8. The information processing apparatus according to claim 7,
wherein the determination of the speech generation is determination of whether the speech generation of the first user is careful speech generation for the second user, and
wherein the predetermined determination result is a determination result representing that the speech generation of the first user is not careful speech generation for the second user.

9. The information processing apparatus according to claim 7, wherein, as the information for identifying the text portion, a color of the text portion is changed, a size of characters of the text portion is changed, a background of the text portion is changed, the text portion is decorated, the text portion is moved, the text portion is vibrated, a display area of the text portion is vibrated, or a display area of the text portion is transformed by the control unit.

10. The information processing apparatus according to claim 1,
wherein the sensing information includes a first voice signal of the first user, wherein the control unit causes a display apparatus to display text acquired by performing voice recognition of the voice signal of the first user,
the information processing apparatus further comprising a communication unit configured to transmit the text to a terminal apparatus of the second user,
wherein the control unit acquires information relating to an understanding status of the second user for the text from the terminal apparatus and controls information output to the first user in accordance with the understanding status of the second user.

11. The information processing apparatus according to claim 10, wherein the information relating to the understanding status includes information relating to whether or not the second user has completed reading the text, information relating to a text portion of the text of which reading by the second user has been completed, information relating to a text portion of the text that is currently being read by the second user, or information relating to a text portion of the text that has not been read by the second user.

12. The information processing apparatus according to claim 11, wherein the control unit acquires the information relating to whether or not the text has been completed to be read on the basis of a direction of a visual line of the second user.

13. The information processing apparatus according to claim 11, wherein the control unit acquires the information relating to whether or the text has been completed to be read by the second user on the basis of a position of the visual line of the second user in a depth direction.

14. The information processing apparatus according to claim 11, wherein the control unit acquires the information relating to the text portion on the basis of a speed at which the second user reads characters.

15. The information processing apparatus according to claim 11, wherein the control unit causes the display apparatus to display information for identifying the text portion.

16. The information processing apparatus according to claim 15, wherein the control unit, as the information for identifying the text portion, changes a color of the text portion, changes a size of characters of the text portion, changes a background of the text portion, decorates the text portion, moves the text portion, vibrates the text portion, vibrates a display area of the text portion, or transforms the display area of the text portion.

17. The information processing apparatus according to claim 1,
wherein the sensing information includes a voice signal of the first user,
wherein the control unit is configured to cause a display apparatus to display text acquired by voice recognition of the voice signal of the first user,
the information processing apparatus further comprising a communication unit configured to transmit the text to a terminal apparatus of the second user,
wherein the communication unit receives a text portion of the text that is designated by the second user, and
wherein the control unit causes the display apparatus to display information for identifying the text portion received by the communication unit.

18. The information processing apparatus according to claim 1, further comprising:
a paralanguage information acquiring unit configured to acquire paralanguage information of the first user on the basis of the sensing information acquired by sensing the first user;
a text decorating unit configured to decorate text acquired by performing voice recognition of a voice signal of the first user on the basis of the paralanguage information; and
a communication unit configured to transmit the decorated text to a terminal apparatus of the second user.

19. An information processing method comprising:
determining speech generated by a first user on the basis of sensing information of at least one sensor apparatus sensing at least one of the first user and a second user communicating with the first user on the basis of the speech generation of the first user; and
controlling information output to the first user on the basis of a result of the determination of the speech generation of the first user.

20. A computer program causing a computer to execute:
a step of determining speech generated by a first user on the basis of sensing information of at least one sensor apparatus sensing at least one of the first user and a second user communicating with the first user on the basis of the speech generation of the first user; and
a step of controlling information output to the first user on the basis of a result of the determination of the speech generation of the first user.
